(19) United States
(12) Patent Application Publication
(10) Pub. No.: US 2020/0027354 A1
(43) Pub. Date: Jan. 23, 2020

(54) Autonomous Vehicle Idle State Task Selection for Improved Computational Resource Usage

(71) Applicant: Uber Technologies, Inc., San Francisco, CA (US)

(72) Inventors: Brent Justin Goldman, San Francisco, CA (US); Leigh Gray Hagestad, San Francisco, CA (US); Rei Chiang, San Francisco, CA (US); Christopher James Lyons, San Francisco, CA (US)

(21) Appl. No.: 16/519,727

(22) Filed: Jul. 23, 2019

Related U.S. Application Data
(60) Provisional application No. 62/729,042, filed on Sep. 10, 2018.
(60) Provisional application No. 62/702,041, filed on Jul. 23, 2018.

(51) Int. Cl. G08G 1/00; G07C 5/00; G05D 1/02

(52) U.S. Cl. CPC G08G 1/202; G05D 2201/0213; G05D 1/0297; G07C 5/008

(57) ABSTRACT

Systems and methods for controlling an autonomous vehicle to reduce wasteful data usage are provided. In one example embodiment, a computing system can determine that a first autonomous vehicle is in an idle state in which the first autonomous vehicle is online with a service entity and is not performing a vehicle service. The computing system can obtain vehicle parameter(s) associated with the first autonomous vehicle that is in the idle state and environmental parameter(s). The computing system can determine a task for the first autonomous vehicle to perform while the first autonomous vehicle is in the idle state based at least in part on at least one of the vehicle parameter(s) or the environmental parameter(s). The computing system can communicate data indicative of the task for the first autonomous vehicle to perform while the first autonomous vehicle is in the idle state.

### PRIORITY CLAIM

The present application is based on and claims the benefit of U.S. Provisional Application No. 62/702,041 having a filing date of Jul. 23, 2018 and U.S. Provisional Application No. 62/729,042 having a filing date of Sep. 10, 2018, both of which are incorporated by reference herein in their entirety for all purposes.

### FIELD

The present disclosure relates generally to controlling autonomous vehicles to efficient use of the computational resources of the autonomous vehicles while in an idle state.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can navigate through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for controlling autonomous vehicles. The method includes determining, by a computing system that includes one or more computing devices, that a first autonomous vehicle is in an idle state in which the first autonomous vehicle is online with a service entity and is not performing a vehicle service. The method includes obtaining, by the computing system, one or more vehicle parameters associated with the first autonomous vehicle that is in the idle state and one or more environmental parameter. The method includes determining, by the computing system, a task for the first autonomous vehicle to perform while the first autonomous vehicle is in the idle state based at least in part on at least one of the one or more vehicle parameters or the one or more environmental parameters. The method includes communicating, by the computing system, data indicative of the task for the first autonomous vehicle to perform while the first autonomous vehicle is in the idle state.

Another example aspect of the present disclosure is directed to a computing system including one or more processors one or more tangible, non-transitory, computer readable media that collectively store instructions that when executed by the one or more processors cause the computing system to perform operations. The operations include determining that an autonomous vehicle is in an idle state, wherein the autonomous vehicle is online with a service entity. The operations include obtaining one or more vehicle parameters associated with the autonomous vehicle that is in the idle state. The operations include determining a task for the autonomous vehicle to perform while the autonomous vehicle is in the idle state based at least in part on at least one of the one or more vehicle parameters. The operations include communicating data indicative of the task for the autonomous vehicle to perform while the autonomous vehicle is in the idle state.

Yet another example aspect of the present disclosure is directed to one or more tangible, non-transitory, computer-readable media that collectively store instructions that, when executed by one or more processors, cause the one or more processors to perform operations. The operations include determining that an autonomous vehicle is in an idle state in which the autonomous vehicle is online with a service entity and is not assigned to a vehicle service assignment. The operations include obtaining one or more vehicle parameters associated with the autonomous vehicle that is in the idle state and one or more environmental parameters. The operations include identifying a plurality of candidate tasks for the autonomous vehicle. The operations include determining, from the plurality of candidate tasks, a task for the autonomous vehicle to perform while the autonomous vehicle is in the idle state based at least in part on at least one of the one or more vehicle parameters or the one or more environmental parameters. The operations include communicating data indicative of the task for the autonomous vehicle to perform while the autonomous vehicle is in the idle state.

Other example aspects of the present disclosure are directed to systems, methods, vehicles, apparatuses, tangible, non-transitory computer-readable media, and memory devices for controlling autonomous vehicles and efficiently using of the computational resources of the autonomous vehicles.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example autonomous vehicle computing system according to example embodiments of the present disclosure;

FIG. 2 depicts example service entity network(s) for an autonomous vehicle according to example embodiments of the present disclosure;

FIG. 3 depicts an example operations computing system of a service entity according to example embodiments of the present disclosure;

FIG. 4 depicts an example data structure including a plurality of candidate tasks according to example embodiments of the present disclosure;

FIG. 5 depicts example geographic areas according to example embodiments of the present disclosure;

FIG. 6 depicts a flow diagram of an example method for controlling autonomous vehicles to reduce computational waste according to example embodiments of the present disclosure; and

FIG. 7 depicts example system components according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improved techniques for decreasing wasteful usage of the data and processing resources of an autonomous vehicle. For instance, an autonomous vehicle can be utilized to perform vehicle services (e.g., transportation services, etc.). The vehicle services can be offered to users by a service entity (e.g., a company that offers and coordinates the provision of vehicle services). In the event that a user requests a vehicle service, a computing system of the service entity can send a vehicle service assignment (e.g., a trip request) to an autonomous vehicle that is online with the service entity. When it is not addressing a vehicle service assignment/performing a vehicle service, an autonomous vehicle can be in an idle state. However, even in the idle state, an autonomous vehicle can continue to acquire sensor data to remain cognizant of its environment (e.g., whether the vehicle is parked, moving, etc.). This can cause the autonomous vehicle to waste its processing, data storage, and power resources while it is not performing a vehicle service.

The systems and methods of the present disclosure can help to reduce such computational waste by selecting tasks for an autonomous vehicle to perform while in an idle state. For instance, a computing system (e.g., of a service entity) can identify that an autonomous vehicle is in an idle state when, for example, the autonomous vehicle is online with the service entity but not performing a vehicle service/assigned to a vehicle service assignment. To identify the best task for the autonomous vehicle, the computing system can obtain vehicle parameter(s) associated with the autonomous vehicle (e.g., current location, charge level, fuel level, restrictions/capabilities, etc.) and/or environmental parameter(s) (e.g., weather, traffic, demand for vehicle services, supply of vehicles to provide vehicle services, proximity of other vehicles, etc.). The computing system can determine a task for the autonomous vehicle to perform while the autonomous vehicle is in the idle state based at least in part on these parameters. For example, if there is another geographic area in which the autonomous vehicle may be more likely to receive a vehicle service assignment (e.g., due to higher demand in that area), the best task for the autonomous vehicle may include re-positioning to that higher demand area. However, if no such opportunity exists, the autonomous vehicle can be assigned a different task such as, for example, acquiring sensor data for studying certain geographic areas, providing assistance to other autonomous vehicles, etc. In this way, autonomous vehicles can be given tasks that help the vehicles productively utilize their computational resources while they are in an idle state, thereby reducing computational waste.

More particularly, an autonomous vehicle (e.g., ground-based vehicle, etc.) can include various systems and devices configured to control the operation of the vehicle. For example, an autonomous vehicle can include an onboard vehicle computing system (e.g., located on or within the autonomous vehicle) that is configured to operate the autonomous vehicle. The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can include a communications system that can allow the vehicle to communicate with a computing system that is remote from the vehicle such as, for example, that of a service entity.

An autonomous vehicle can perform vehicle services for one or more service entities. A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of vehicle service(s) to one or more users. For example, a service entity can offer vehicle service(s) to users via a software application (e.g., on a user computing device), via a website, and/or via other types of interfaces that allow a user to request a vehicle service. The vehicle services can include user transportation services (e.g., by which the vehicle transports user(s) from one location to another), delivery services (e.g., by which a vehicle delivers item(s) to a requested destination location), courier services (e.g., by which a vehicle retrieves item(s) from a requested origin location and delivers the item to a requested destination location), and/or other types of services.

A user can provide (e.g., via a user device) a request for a vehicle service to an operations computing system associated with the service entity. The request can indicate the type of vehicle service that the user desires (e.g., a user transportation service, a delivery service, a courier service, etc.), one or more locations (e.g., an origin, destination, etc.), timing constraints (e.g., pick-up time, drop-off time, deadlines, etc.), a number of user(s) and/or items to be transported in the vehicle, other service parameters (e.g., a need for handicap access, handle with care instructions, etc.), and/or other information.

The operations computing system of the service entity can process the request and identify one or more autonomous vehicles that may be able to perform the requested vehicle services for the user. For instance, the operations computing system can identify which autonomous vehicle(s) are online with the service entity (e.g., available for a vehicle service assignment, addressing a vehicle service assignment, etc.). An autonomous vehicle can go online with a service entity by, for example, connecting with the service entity's operations computing system so that the vehicle computing system can communicate with the operations computing system via a network of the service entity. Once online, the operations computing system can communicate a vehicle service assignment indicative of the requested vehicle services and/or other data to the autonomous vehicle.

An autonomous vehicle can enter into an idle state while it is online with the service entity. For instance, an autonomous vehicle can be in an idle state when the autonomous vehicle is online with the service entity and is not assigned to a vehicle service assignment and/or performing a vehicle service. By way of example, an online autonomous vehicle can enter into an idle state after the autonomous vehicle finishes performing a vehicle service for a vehicle service assignment (e.g., drops off a user at a destination location in accordance with a trip request). The idle state can, thus, indicate the time at which the autonomous vehicle is available to perform a vehicle service but is not currently performing one (e.g., traveling to an origin location, transporting an item/user, traveling to a destination location, etc.).

The operations computing system can determine that an autonomous vehicle is in an idle state. In some implementations, an autonomous vehicle itself can communicate data to the operations computing system indicating that the autonomous vehicle has entered into an idle state and/or that the autonomous vehicle has completed a vehicle service assignment. In some implementations, a third party computing system (e.g., that is remote from the autonomous vehicle and associated with a third party vehicle provider) can communicate such data to the operations computing system. In some implementations, the operations computing system can monitor an autonomous vehicle to determine that the autonomous vehicle has entered into an idle state. For instance, the operations computing system can obtain data indicating that the autonomous vehicle has completed a vehicle service assignment and determine that the autonomous vehicle is not assigned to another vehicle service assignment.

The service entity can aim to ensure that an autonomous vehicle is productively utilizing its computational resources while it is in an idle state. To do so, the operations computing system can determine a task for the autonomous vehicle to perform while the autonomous vehicle is in the idle state. There may be a plurality of candidate tasks (stored in an accessible memory) for the autonomous vehicle to perform and the operations computing system can be configured to select the most appropriate task for that vehicle, as further described herein. A task can be associated with an activity other than the performance of a vehicle service (e.g., transportation service).

In some implementations, the tasks can be associated with the furtherance of the service entity's business and/or the development of autonomous vehicles associated with the service entity. Such a task can include, for example, a testing task or a data acquisition task. A testing task can include the autonomous vehicle testing software and/or hardware that is implemented on the autonomous vehicle. This can include testing software associated with the vehicle's autonomy computing system (e.g., perception, prediction, motion planning, etc. software) and hardware (e.g., sensor hardware, etc.). A data acquisition task can include acquiring sensor data associated with certain travel ways (e.g., for map generation, etc.) and/or the acquisition of sensor data associated with a condition in a geographic area (e.g., a scouting task to acquire sensor data associated with a travel way that has potentially changed, an obstruction, an accident, etc.).

In some implementations, the tasks can be associated with the re-repositioning of the autonomous vehicle. This can include, for example, a supply re-positioning task that instructs the autonomous vehicle to travel from a current location within a first geographic area to another location within a second geographic area. The second geographic area can have an imbalance in a number of vehicles associated with the second geographic area (e.g., a deficit in the number of autonomous vehicles as compared to a demand for vehicle services). Additionally, or alternatively, the task can include a circling task whereby the autonomous vehicle is to travel within the current geographic area in which it is located (e.g., circle the block or neighborhood). Additionally, or alternatively, the tasks can be associated with making the autonomous vehicle stationary. This can include, for example, a parking task by which the autonomous vehicle is to park.

In some implementations, the tasks can be associated with maintenance of the autonomous vehicle. For instance, a maintenance task can include the autonomous vehicle travelling to a service depot to receive scheduled maintenance, upgrade a software version, re-charge, re-fuel, and/or obtain other maintenance/servicing.

In some implementations, the tasks can be associated with assisting other vehicles. This can include a vehicle assistance task by which the autonomous vehicle in the idle state travels to assist another vehicle (e.g., autonomous vehicle, non-autonomous vehicle, etc.). For example, a first autonomous vehicle may experience a fault such that the first autonomous vehicle performs a safe stop maneuver and pulls-over to the side of a travel way. A second autonomous vehicle (in an idle state) can be sent to assist the first autonomous vehicle by picking-up any users that are being transporting in the first autonomous vehicle. In another example, the sensors of a first autonomous vehicle can be occluded (e.g., due to a barrier, obstruction, etc.). A vehicle assistance task can instruct a second autonomous vehicle that is in an idle state to travel to a location that allows the second autonomous vehicle to acquire sensor data associated with the occluded area and transmit that sensor data to the first autonomous vehicle. This can allow the first autonomous vehicle to understand what might be in the occluded area and plan its motion accordingly.

In some implementations, the autonomous vehicle may be assigned a deactivation task. This can include the autonomous vehicle going offline with respect to the service entity. A deactivation task can be considered a last resort in the event that another task is not available for the autonomous vehicle.

The type of task selected for an autonomous vehicle can be based on a variety of information. For instance, the operations computing system can obtain one or more vehicle parameters associated with an autonomous vehicle that is in an idle state. The vehicle parameter(s) can be indicative of the past, present, and/or future state, operating conditions, characteristics, etc. associated with the autonomous vehicle. For example, the vehicle parameter(s) can include data indicative of at least one of a current location of the autonomous vehicle, an electric charge level of the autonomous vehicle, a fuel level of the autonomous vehicle, an available data storage level of the autonomous vehicle, a maintenance schedule of the autonomous vehicle, a particular version of software implemented on the autonomous vehicle, a restriction associated with the autonomous vehicle (e.g., geographic restriction, vehicle capability set, etc.), whether the vehicle is stopped, whether the vehicle is parked, etc. In some implementations, the vehicle parameter(s) can be indicative of a condition of the autonomous vehicle relative to other autonomous vehicle(s) and/or geographic areas. For example, the vehicle parameter(s) can include data indicative of a physical proximity of the autonomous vehicle to other vehicles that are online with the service entity, a physical proximity of the autonomous vehicle to a certain geographic area (e.g., one with a high level of vehicle service demand), etc. In some implementations, the vehicle parameter(s) can include data indicative of whether the autonomous vehicle is associated with a third party vehicle provider (e.g., vehicle vendor), any preferences associated with the vehicle and/or a third party vehicle provider (e.g., preferred operating areas, preferred destination areas, preferred types of tasks, etc.), etc. In some implementations, the vehicle parameter(s) can be indicative of service-related information. For example, the vehicle parameter(s) can include data indicative of how long the autonomous vehicle has been idle, a number of vehicle service assignments completed by the autonomous vehicle (e.g., the number of trips taken by the autonomous vehicle), a vehicle service assignment requirement associated with the autonomous vehicle and/or a third party vehicle provider (e.g., the number of trips that the autonomous vehicle is required to take in a given day), etc.

Additionally, or alternatively, the operations computing system can obtain one or more environmental parameters. The environmental parameter(s) can be associated with at least one of an environment in which the autonomous vehicle is operating or the service entity (e.g., the market for the service entity's vehicle services, the other vehicles that are online with the service entity, etc.). For example, the environmental parameter(s) can be indicative of a weather condition (e.g., rain, snow, etc.), a traffic condition (e.g., traffic patterns, congestion levels, etc.), an event (e.g., concert, sporting event, protest, etc.), a fuel/charge price, available parking, service depot availability, and/or other information associated with a geographic area in which the autonomous vehicle is (or will be) located in or nearby. In some implementations, the environmental parameters can be indicative of information associated with other vehicles. For example, the environmental parameters can be indicative of the location of other vehicles (e.g., autonomous vehicles, non-autonomous vehicles) that are online with the service entity and/or the location of one or more vehicles that are offline with the service entity. In some implementations, the environmental parameter(s) can be indicative of information associated with the service entity such as, for example, a past, current, and/or future projected demand for vehicle services, a number of vehicles that are online with the service entity, one or more geographic area(s) in which the service entity offers vehicle services (e.g., geographic areas experiencing or projected to experience higher demand than available vehicle supply), etc.

The operations computing system can determine which task is to be performed by the autonomous vehicle while it is in an idle state based at least in part on the vehicle parameter(s) and/or the environmental parameter(s). In some implementations, the operations computing system can utilize heuristics to rank tasks and/or determine which task is best for the autonomous vehicle. For example, the operations computing system can utilize a rules-based model that is written to evaluate the different vehicle parameter(s) and/or environmental parameter(s) and rank tasks and/or select a task for the idle autonomous vehicle based at least in part on these parameter(s). The operations computing system can also, or alternatively, utilize a machine-learned model to determine a task for an autonomous vehicle to perform while in the idle state. The model can be trained to evaluate the vehicle parameter(s) and/or environment parameter(s) as input data and rank tasks and/or determine a recommended task for an autonomous vehicle (which can be provided as output data).

In some implementations, the operations computing system can utilize a weighting scheme to determine which task to select for an autonomous vehicle. For example, each task can be associated with a priority weight/value that is indicative of the importance, urgency, etc. of that task. The priority weight can be based at least in part on a specific geographic area. For example, for a newer market/geographic area, there may be a higher weight/value placed on data acquisition tasks (e.g., mapping tasks, scouting tasks, etc.) to help gain a further understanding of the market/area. In some implementations, the weighting scheme can be a dynamic weighting scheme that changes based on current and/or future vehicle parameter(s) and/or environmental parameter(s). For example, in the event that there are several distressed autonomous vehicles, a higher priority weight can be afforded to a vehicle assistance task. In another example, a higher priority weight can be afforded to a maintenance task in the event that an autonomous vehicle requires more urgent maintenance. In some implementations, the weighting scheme can be based at least in part on vehicle capabilities, restrictions, and/or preferences. For example, in the event that an autonomous vehicle is restricted to operate within a certain geographic area (or a third party vehicle provider has indicated a preference as such), a higher priority weight can be afforded to a circling task and/or another type of task that can be performed in that certain geographic area.

In some implementations, the operations computing system can utilize a task hierarchy (e.g., stored in a hierarchical tree data structure) to rank tasks and/or determine a task for the autonomous vehicle. The task hierarchy can be indicative of the priority weights of the candidate tasks for an autonomous vehicle. For example, the task hierarchy can assign a highest priority weight to a supply re-positioning task (e.g., to increase the opportunity for the vehicle to receive a vehicle service assignment) and a lowest priority weight to a de-activation task (e.g., whereby the vehicle goes offline). One or more other tasks may be assigned a priority weight between the supply re-positioning task and the de-activation task.

The following provides example task determinations that can be made by the operations computing system for an autonomous vehicle based at least in part on the vehicle and/or environmental parameter(s). For instance, the operations computing system can determine that an autonomous vehicle is to perform a supply re-positioning task (e.g., re-locate to another geographic area) in the event that the autonomous vehicle is not restricted from travelling to the other geographic area and in the event that the other geographic area is experiencing a vehicle imbalance (e.g., a deficit in the supply of vehicles as compared to vehicle service demand). In another example, in the event that supply re-positioning is not available or is a low priority (e.g., because there is not a geographic area with a vehicle imbalance, because traffic would prevent the autonomous vehicle from re-locating, etc.), the operations computing system can select another task for the autonomous vehicle. For instance, in the event that the autonomous vehicle is operating in a geographic area for which additional map data is needed and/or for which there has been a change in a condition (e.g., a redeveloped travel way), the operations computing system can select a data acquisition task for the autonomous vehicle. In another example, in the event that the autonomous vehicle has completed its requisite number of vehicle service assignments and a nearby autonomous vehicle has experienced a fault, the operations computing system can select a vehicle assistance task for the autonomous vehicle (e.g., to assist the nearby distressed vehicle). In another example, in the event of an inclement weather event (e.g., hail), the operations computing system can determine that the autonomous vehicle is to park within the geographic area in which it is located, such as in a designated covered parking area.

The operations computing system can communicate data indicative of the task for the autonomous vehicle to perform while the autonomous vehicle is in the idle state. Such data can be communicated directly or indirectly to the autonomous vehicle(s). For example, the operations computing system can communicate data indicative of a task directly to an autonomous vehicle that is online with the service entity (e.g., via the service entity's platform/network, etc.). Additionally, or alternatively, data indicative of the task can be communicated to a third party vehicle provider associated with the autonomous vehicle, which can in turn communicate the data indicative of the task to the autonomous vehicle and/or determine whether the autonomous vehicle should undertake the selected task.

The operations computing system can confirm that an autonomous vehicle has undertaken and/or completed a task. For example, the operations computing system can obtain data indicative of an acceptance of the task from an autonomous vehicle. Additionally, or alternatively, the operations computing system can determine whether the autonomous vehicle is acting in accordance with the task. For example, the operations computing system can obtain data indicative of a vehicle's motion plan to determine whether the autonomous vehicle intends to complete a task as instructed (e.g., re-positioning with respect a certain geographic area, performing a data acquisition task, travelling to assist a vehicle, travelling to a service depot for maintenance, etc.). The operations computing system can confirm that the autonomous vehicle has completed (or will soon complete) a task based at least in part on data indicative of the completion as communicated by the autonomous vehicle (or a related vehicle provider computing system). Additionally, or alternatively, the operations computing system can monitor the activity of the autonomous vehicle to determine whether the vehicle has completed the selected task (e.g., arrived at the geographic area with a vehicle imbalance). Once the autonomous vehicle completes a task (or nears completion of the task), the operations computing system can determine whether to select another task for the autonomous vehicle or, if available, communicate a vehicle service assignment to the autonomous vehicle.

In some implementations, a task can be overridden by a vehicle service assignment. Stated differently, an autonomous vehicle which has been provided both a task to perform and a vehicle service assignment can prioritize performance of the vehicle service assignment over performance of the task. For instance, an idle autonomous vehicle can obtain data indicative of a task and undertake the task. By way of example, the autonomous vehicle can begin to travel to a geographic area that is experiencing vehicle imbalance, as instructed for a supply re-positioning task. While en route to the geographic area (e.g., during performance of the task), the autonomous vehicle may obtain a vehicle service assignment. As such, the autonomous vehicle can accept and address the vehicle service assignment (e.g., travel to pick-up a user, etc.), before completing the supply re-positioning task. In another example, the operations computing system can communicate data indicative of a task to an autonomous vehicle that is currently addressing a vehicle service assignment (e.g., travelling to pick-up a user/item, transporting the user/item, etc.). The operations computing system may do so in order to forward deploy the task so that the autonomous vehicle will perform the task after completing the current vehicle service assignment (e.g., to proactively utilize the vehicle's potential idle time). In the event that the autonomous vehicle obtains a subsequent vehicle service assignment, the autonomous vehicle can perform the vehicle service assignment before performing the task.

In some implementations, the operations computing system can incentivize an autonomous vehicle and/or an associated vehicle provider to undertake a task. For example, the operations computing system can provide the autonomous vehicle with a financial incentive, increased vehicle rating, priority treatment for vehicle service assignments, etc. as a method to incentivize the acceptance of the selected task.

The systems and methods described herein provide a number of technical effects and benefits. More particularly, the systems and methods of the present disclosure provide improved techniques for decreasing wasteful idle data usage. To do so, aspects of the present disclosure allow a computing system to select tasks for autonomous vehicle(s) to perform while in an idle state, thereby, increasing the productive utilization of the autonomous vehicle and its computational resources. Ultimately, the performance of the various tasks can lead to improved opportunities for vehicle service assignments (e.g., via a re-positioning task), improve autonomous vehicle development (e.g., via data acquisition tasks), improve assistance to distressed vehicles (e.g., via vehicle assistance tasks), etc.

Example aspects of the present disclosure can provide an improvement to vehicle computing technology, such as autonomous vehicle computing technology. For instance, the systems and methods of the present disclosure provide an improved approach to productively utilizing the computational resources of an idle autonomous vehicle. For example, a computing system (e.g., an operations computing system that is remote from the autonomous vehicle) can determine that an autonomous vehicle is in an idle state in which the autonomous vehicle is online with a service entity and is not performing a vehicle service and/or not currently assigned to a vehicle service assignment. The computing system can obtain one or more vehicle parameters associated with the autonomous vehicle that is in the idle state and one or more environmental parameters. The computing system can determine a task for the autonomous vehicle to perform while the autonomous vehicle is in the idle state based at least in part on at least one of the one or more vehicle parameters or the one or more environmental parameters. The task can be an activity other than performing a vehicle service (e.g., transportation, delivery, courier, etc.). The computing system can communicate data indicative of the task for the autonomous vehicle to perform while the autonomous vehicle is in the idle state. In this way, a computing system can determine the best task for an autonomous vehicle based on the vehicle and/or environmental parameter(s). Moreover, the computing system can strategically determine which tasks to assign to an autonomous vehicle based on a prioritization of the tasks and their fit to the autonomous vehicle (e.g., as indicated by the parameter(s)). For example, an autonomous vehicle that can readily be re-positioned to a geographic area with a deficit in vehicle supply can be assigned a supply re-positioning task, while an autonomous vehicle nearby a distressed autonomous vehicle can be assigned a vehicle assistance task. Accordingly, the computing system can re-position the autonomous vehicle(s) so that the processing, memory, and power resources of the vehicle's computing system are more likely to be utilized in a productive manner to benefit the individual autonomous vehicle (e.g., by increasing the likelihood that the autonomous vehicle will receive vehicle service assignments and avoiding idle data usage) and/or to help the overall autonomous operations of the vehicle fleet (e.g., by acquiring needed data, helping other vehicles, etc.). This leads to a more productive use of a vehicle's computational resources, while reducing the need for autonomous vehicles to go offline to preserve such resources. Ultimately, the computing system can decrease wasteful usage of the computational resources for idle autonomous vehicles.

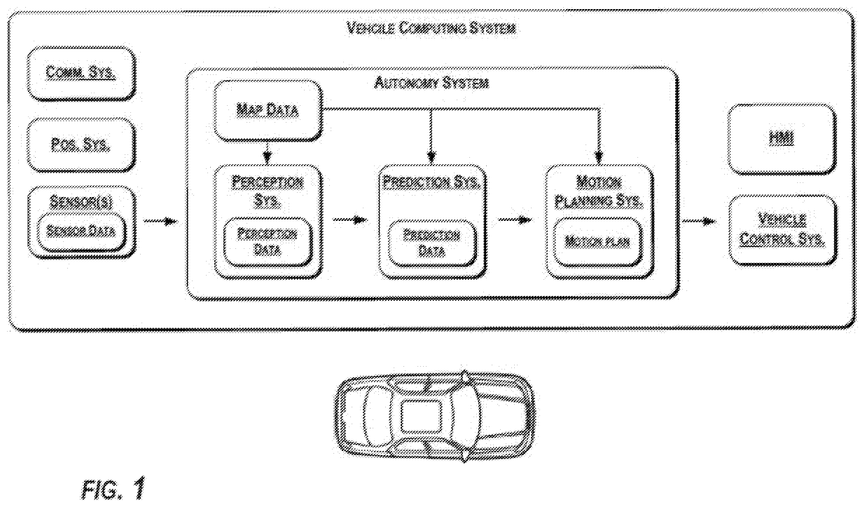

With reference now to the FIGS., example embodiments of the present disclosure will be discussed in further detail. FIG. 1 illustrates an example vehicle computing system 100 according to example embodiments of the present disclosure. The vehicle computing system 100 can be associated with an autonomous vehicle 105. The vehicle computing system 100 can be located onboard (e.g., included on and/or within) the autonomous vehicle 105.

The autonomous vehicle 105 incorporating the vehicle computing system 100 can be various types of vehicles. For instance, the autonomous vehicle 105 can be a ground-based autonomous vehicle such as an autonomous car, autonomous truck, autonomous bus, etc. The autonomous vehicle 105 can be an air-based autonomous vehicle (e.g., airplane, helicopter, or other aircraft) or other types of vehicles (e.g., watercraft, etc.). The autonomous vehicle 105 can drive, navigate, operate, etc. with minimal and/or no interaction from a human operator (e.g., driver). In some implementations, a human operator can be omitted from the autonomous vehicle 105 (and/or also omitted from remote control of the autonomous vehicle 105). In some implementations, a human operator can be included in the autonomous vehicle 105.

In some implementations, the autonomous vehicle 105 can be configured to operate in a plurality of operating modes. The autonomous vehicle 105 can be configured to operate in a fully autonomous (e.g., self-driving) operating mode in which the autonomous vehicle 105 is controllable without user input (e.g., can drive and navigate with no input from a human operator present in the autonomous vehicle 105 and/or remote from the autonomous vehicle 105). The autonomous vehicle 105 can operate in a semi-autonomous operating mode in which the autonomous vehicle 105 can operate with some input from a human operator present in the autonomous vehicle 105 (and/or a human operator that is remote from the autonomous vehicle 105). The autonomous vehicle 105 can enter into a manual operating mode in which the autonomous vehicle 105 is fully controllable by a human operator (e.g., human driver, pilot, etc.) and can be prohibited and/or disabled (e.g., temporary, permanently, etc.) from performing autonomous navigation (e.g., autonomous driving). In some implementations, the autonomous vehicle 105 can implement vehicle operating assistance technology (e.g., collision mitigation system, power assist steering, etc.) while in the manual operating mode to help assist the human operator of the autonomous vehicle 105.

The operating modes of the autonomous vehicle 105 can be stored in a memory onboard the autonomous vehicle 105. For example, the operating modes can be defined by an operating mode data structure (e.g., rule, list, table, etc.) that indicates one or more operating parameters for the autonomous vehicle 105, while in the particular operating mode. For example, an operating mode data structure can indicate that the autonomous vehicle 105 is to autonomously plan its motion when in the fully autonomous operating mode. The vehicle computing system 100 can access the memory when implementing an operating mode.

The operating mode of the autonomous vehicle 105 can be adjusted in a variety of manners. For example, the operating mode of the autonomous vehicle 105 can be selected remotely, off-board the autonomous vehicle 105. For example, a remote computing system (e.g., of a vehicle provider and/or service entity associated with the autonomous vehicle 105) can communicate data to the autonomous vehicle 105 instructing the autonomous vehicle 105 to enter into, exit from, maintain, etc. an operating mode. By way of example, such data can instruct the autonomous vehicle 105 to enter into the fully autonomous operating mode. In some implementations, the operating mode of the autonomous vehicle 105 can be set onboard and/or near the autonomous vehicle 105. For example, the vehicle computing system 100 can automatically determine when and where the autonomous vehicle 105 is to enter, change, maintain, etc. a particular operating mode (e.g., without user input). Additionally, or alternatively, the operating mode of the autonomous vehicle 105 can be manually selected via one or more interfaces located onboard the autonomous vehicle 105 (e.g., key switch, button, etc.) and/or associated with a computing device proximate to the autonomous vehicle 105 (e.g., a tablet operated by authorized personnel located near the autonomous vehicle 105). In some implementations, the operating mode of the autonomous vehicle 105 can be adjusted by manipulating a series of interfaces in a particular order to cause the autonomous vehicle 105 to enter into a particular operating mode.

The vehicle computing system 100 can include one or more computing devices located onboard the autonomous vehicle 105. For example, the computing device(s) can be located on and/or within the autonomous vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the autonomous vehicle 105 (e.g., its computing system, one or more processors, etc.) to perform operations and functions, such as those described herein for controlling an autonomous vehicle, activating an autonomous vehicle, recognizing that an autonomous vehicle is idle, implementing a task, de-activating an autonomous vehicle, etc.

The autonomous vehicle 105 can include a communications system 120 configured to allow the vehicle computing system 100 (and its computing device(s)) to communicate with other computing devices. The vehicle computing system 100 can use the communications system 120 to communicate with one or more computing device(s) that are remote from the autonomous vehicle 105 over one or more networks (e.g., via one or more wireless signal connections). In some implementations, the communications system 120 can allow communication among one or more of the system(s) on-board the autonomous vehicle 105. The communications system 120 can include any suitable components for interfacing with one or more network(s), including, for example, transmitters, receivers, ports, controllers, antennas, and/or other suitable components that can help facilitate communication.

As shown in FIG. 1, the autonomous vehicle 105 can include one or more vehicle sensors 125, an autonomy computing system 130, one or more vehicle control systems 135, and other systems, as described herein. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel.

The vehicle sensor(s) 125 can be configured to acquire sensor data 140. This can include sensor data associated with the surrounding environment of the autonomous vehicle 105. For instance, the sensor data 140 can acquire image and/or other data within a field of view of one or more of the vehicle sensor(s) 125. The vehicle sensor(s) 125 can include a Light Detection and Ranging (LIDAR) system, a Radio Detection and Ranging (RADAR) system, one or more cameras (e.g., visible spectrum cameras, infrared cameras, etc.), motion sensors, and/or other types of imaging capture devices and/or sensors. The sensor data 140 can include image data, radar data, LIDAR data, and/or other data acquired by the vehicle sensor(s) 125. The autonomous vehicle 105 can also include other sensors configured to acquire data associated with the autonomous vehicle 105. For example, the autonomous vehicle 105 can include inertial measurement unit(s), wheel odometry devices, and/or other sensors.

In some implementations, the sensor data 140 can be indicative of one or more objects within the surrounding environment of the autonomous vehicle 105. The object(s) can include, for example, vehicles, pedestrians, bicycles, and/or other objects. The object(s) can be located in front of, to the rear of, to the side of the autonomous vehicle 105, etc. The sensor data 140 can be indicative of locations associated with the object(s) within the surrounding environment of the autonomous vehicle 105 at one or more times. The vehicle sensor(s) 125 can provide the sensor data 140 to the autonomy computing system 130.

In addition to the sensor data 140, the autonomy computing system 130 can retrieve or otherwise obtain map data 145. The map data 145 can provide information about the surrounding environment of the autonomous vehicle 105. In some implementations, an autonomous vehicle 105 can obtain detailed map data that provides information regarding: the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); and/or any other map data that provides information that assists the autonomous vehicle 105 in comprehending and perceiving its surrounding environment and its relationship thereto. In some implementations, the vehicle computing system 100 can determine a vehicle route for the autonomous vehicle 105 based at least in part on the map data 145.

The autonomous vehicle 105 can include a positioning system 150. The positioning system 150 can determine a current position of the autonomous vehicle 105. The positioning system 150 can be any device or circuitry for analyzing the position of the autonomous vehicle 105. For example, the positioning system 150 can determine position by using one or more of inertial sensors (e.g., inertial measurement unit(s), etc.), a satellite positioning system, based on IP address, by using triangulation and/or proximity to network access points or other network components (e.g., cellular towers, WiFi access points, etc.) and/or other suitable techniques. The position of the autonomous vehicle 105 can be used by various systems of the vehicle computing system 100 and/or provided to a remote computing system. For example, the map data 145 can provide the autonomous vehicle 105 relative positions of the elements of a surrounding environment of the autonomous vehicle 105. The autonomous vehicle 105 can identify its position within the surrounding environment (e.g., across six axes, etc.) based at least in part on the map data 145. For example, the vehicle computing system 100 can process the sensor data 140 (e.g., LIDAR data, camera data, etc.) to match it to a map of the surrounding environment to get an understanding of the vehicle's position within that environment.

The autonomy computing system 130 can include a perception system 155, a prediction system 160, a motion planning system 165, and/or other systems that cooperate to perceive the surrounding environment of the autonomous vehicle 105 and determine a motion plan for controlling the motion of the autonomous vehicle 105 accordingly. For example, the autonomy computing system 130 can obtain the sensor data 140 from the vehicle sensor(s) 125, process the sensor data 140 (and/or other data) to perceive its surrounding environment, predict the motion of objects within the surrounding environment, and generate an appropriate motion plan through such surrounding environment. The autonomy computing system 130 can communicate with the one or more vehicle control systems 135 to operate the autonomous vehicle 105 according to the motion plan.

The vehicle computing system 100 (e.g., the autonomy computing system 130) can identify one or more objects that are proximate to the autonomous vehicle 105 based at least in part on the sensor data 140 and/or the map data 145. For example, the vehicle computing system 100 (e.g., the perception system 155) can process the sensor data 140, the map data 145, etc. to obtain perception data 170. The vehicle computing system 100 can generate perception data 170 that is indicative of one or more states (e.g., current and/or past state(s)) of a plurality of objects that are within a surrounding environment of the autonomous vehicle 105. For example, the perception data 170 for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape); class (e.g., pedestrian class vs. vehicle class vs. bicycle class), the uncertainties associated therewith, and/or other state information. The perception system 155 can provide the perception data 170 to the prediction system 160 (and/or the motion planning system 165).

The prediction system 160 can be configured to predict a motion of the object(s) within the surrounding environment of the autonomous vehicle 105. For instance, the prediction system 160 can generate prediction data 175 associated with such object(s). The prediction data 175 can be indicative of one or more predicted future locations of each respective object. For example, the prediction system 160 can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 175 can be indicative of the speed and/or acceleration at which the respective object is predicted to travel along its associated predicted motion trajectory. The prediction system 160 can output the prediction data 175 (e.g., indicative of one or more of the predicted motion trajectories) to the motion planning system 165.

The vehicle computing system 100 (e.g., the motion planning system 165) can determine a motion plan 180 for the autonomous vehicle 105 based at least in part on the perception data 170, the prediction data 175, and/or other data. A motion plan 180 can include vehicle actions (e.g., planned vehicle trajectories, speed(s), acceleration(s), other actions, etc.) with respect to one or more of the objects within the surrounding environment of the autonomous vehicle 105 as well as the objects' predicted movements. For instance, the motion planning system 165 can implement an optimization algorithm, model, etc. that considers cost data associated with a vehicle action as well as other objective functions (e.g., cost functions based on speed limits, traffic lights, etc.), if any, to determine optimized variables that make up the motion plan 180. The motion planning system 165 can determine that the autonomous vehicle 105 can perform a certain action (e.g., pass an object, etc.) without increasing the potential risk to the autonomous vehicle 105 and/or violating any traffic laws (e.g., speed limits, lane boundaries, signage, etc.). For instance, the motion planning system 165 can evaluate one or more of the predicted motion trajectories of one or more objects during its cost data analysis as it determines an optimized vehicle trajectory through the surrounding environment. The motion planning system 165 can generate cost data associated with such trajectories. In some implementations, one or more of the predicted motion trajectories may not ultimately change the motion of the autonomous vehicle 105 (e.g., due to an overriding factor). In some implementations, the motion plan 180 may define the vehicle's motion such that the autonomous vehicle 105 avoids the object(s), reduces speed to give more leeway to one or more of the object(s), proceeds cautiously, performs a stopping action, etc.

The motion planning system 165 can be configured to continuously update the vehicle's motion plan 180 and a corresponding planned vehicle motion trajectory. For example, in some implementations, the motion planning system 165 can generate new motion plan(s) for the autonomous vehicle 105 (e.g., multiple times per second). Each new motion plan can describe a motion of the autonomous vehicle 105 over the next planning period (e.g., next several seconds). Moreover, a new motion plan may include a new planned vehicle motion trajectory. Thus, in some implementations, the motion planning system 165 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed by the autonomous vehicle 105.

The vehicle computing system 100 can cause the autonomous vehicle 105 to initiate a motion control in accordance with at least a portion of the motion plan 180. A motion control can be an operation, action, etc. that is associated with controlling the motion of the vehicle. For instance, the motion plan 180 can be provided to the vehicle control system(s) 135 of the autonomous vehicle 105. The vehicle control system(s) 135 can be associated with a vehicle controller (e.g., including a vehicle interface) that is configured to implement the motion plan 180. The vehicle controller can, for example, translate the motion plan into instructions for the appropriate vehicle control component (e.g., acceleration control, brake control, steering control, etc.). By way of example, the vehicle controller can translate a determined motion plan 180 into instructions to adjust the steering of the autonomous vehicle 105 “X” degrees, apply a certain magnitude of braking force, etc. The vehicle controller (e.g., the vehicle interface) can help facilitate the responsible vehicle control (e.g., braking control system, steering control system, acceleration control system, etc.) to execute the instructions and implement the motion plan 180 (e.g., by sending control signal(s), making the translated plan available, etc.). This can allow the autonomous vehicle 105 to autonomously travel within the vehicle's surrounding environment.

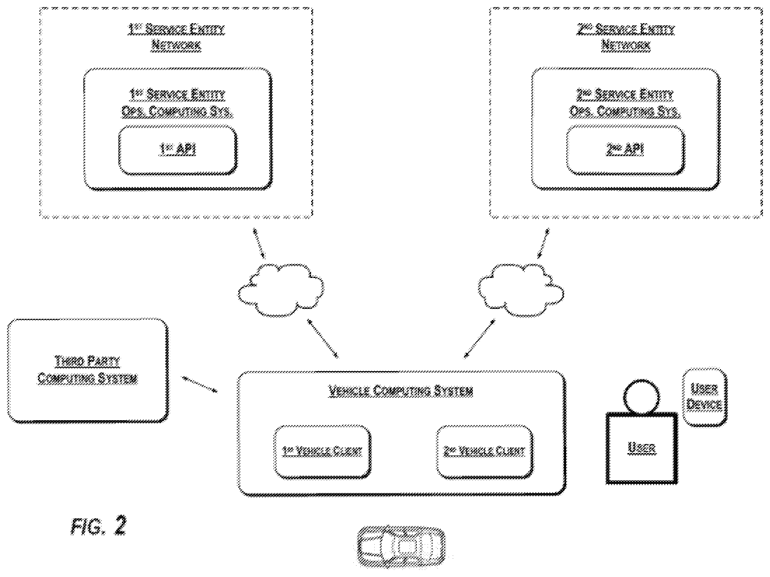

The autonomous vehicle 105 can be associated with a variety of different parties. For example, FIG. 2 depicts an example architecture 200 according to example embodiments of the present disclosure. As shown, the vehicle computing system 100 of the autonomous vehicle 105 can be configured to communicate with a plurality of different computing systems that are remote from the autonomous vehicle 105 via the architecture 200.

In some implementations, the autonomous vehicle 105 can be associated with a vehicle provider 205. The vehicle provider 205 can include, for example, an owner, a manufacturer, a vendor, a manager, a coordinator, a handler, etc. of the autonomous vehicle 105. The vehicle provider 205 can be an individual, a group of individuals, an entity (e.g., a company), a group of entities, a service entity, etc. In some implementations, the autonomous vehicle 105 can be included in a fleet of vehicles associated with the vehicle provider 205. The vehicle provider 205 can utilize a vehicle provider computing system 210 that is remote from the autonomous vehicle 105 to communicate (e.g., over one or more wireless communication channels) with the vehicle computing system 100 of the autonomous vehicle 105. The vehicle provider computing system 210 can include a server system (e.g., of an entity), a user device (e.g., of an individual owner), and/or other types of computing systems.

The autonomous vehicle 105 can be configured to perform vehicle services for a plurality of different service entities 215A-B. An autonomous vehicle 105 can perform a vehicle service by, for example and as further described herein, travelling (e.g., traveling autonomously) to a location associated with a requested vehicle service, allowing user(s) and/or item(s) to board or otherwise enter the autonomous vehicle 105, transporting the user(s) and/or item(s), allowing the user(s) and/or item(s) to deboard or otherwise exit the autonomous vehicle 105, etc. In this way, the autonomous vehicle 105 can provide the vehicle service(s) for a service entity to a user.

A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users. For example, a service entity can offer vehicle service(s) to users via one or more software applications (e.g., that are downloaded onto a user computing device), via a website, and/or via other types of interfaces that allow a user to request a vehicle service. As described herein, the vehicle services can include transportation services (e.g., by which a vehicle transports user(s) from one location to another), delivery services (e.g., by which a vehicle transports/delivers item(s) to a requested destination location), courier services (e.g., by which a vehicle retrieves item(s) from a requested origin location and transports/delivers the item to a requested destination location), and/or other types of services.

Each service entity 215A-B can be associated with a respective telecommunications network system 220A-B of that service entity. A telecommunications network system can include the infrastructure to facilitate communication between the autonomous vehicle 105 and the various computing systems of the associated service entity that are remote from the autonomous vehicle 105. For example, a service entity 215A-B can utilize an operations computing system 225A-B of the service entity to communicate with, coordinate, manage, etc. autonomous vehicle(s) to perform the vehicle services of the service entity 215A-B. A telecommunications network system 220A-B can allow an autonomous vehicle 105 to utilize the back-end functionality of the respective operations computing system 225A-B (e.g., vehicle service assignment allocation, vehicle technical support, etc.). For example, the task selection systems and processes of the present disclosure can be associated with a back-end service that includes and/or is dedicated to performing such functionality.

An operations computing system 225A-B can include one or more computing devices that are remote from the autonomous vehicle 105 (e.g., located off-board the autonomous vehicle 105). For example, such computing device(s) can be components of a cloud-based server system and/or other type of computing system that can communicate with the vehicle computing system 100 of the autonomous vehicle 105, another computing system (e.g., a vehicle provider computing system 210, etc.), a user device, etc. The operations computing system 225A-B can be, for example, a data center for the service entity 215A-B. The operations computing system 225A-B can be distributed across one or more location(s) and include one or more sub-systems. The computing device(s) of an operations computing system 225A-B can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system 225A-B (e.g., the one or more processors, etc.) to perform operations and functions, such as communicating data to and/or obtaining data from vehicle(s), obtaining data associated with various tasks, identifying vehicle imbalances, re-positioning vehicles, coordinating the provision of vehicle services by vehicle(s), ranking/selecting/assigning tasks, etc. as further described herein.

An operations computing system 225A-B can communicate with an autonomous vehicle 105 via the service entity's computing platform. A computing platform of a service entity 215A-B can provide the vehicle computing system 100 and the operations computing system 225A-B with a computing environment that allows the systems to communicate. A computing platform can include a variety of computer architectures. Moreover, the computing platform can include the software, hardware, application programming interface(s), etc. that are associated with the service entity 215A-B. Each service entity 215A-B may have a different computing platform that can allow the service entity's operations computing system 225A-B and the vehicle computing system 100 to communicate via the telecommunications network system 220A-B associated with that service entity. In some implementations, one or more service entities may utilize the same computing platform.

One or more of the components of a computing platform can be accessible by the vehicle computing system 100. For instance, to help communicate with the various different service entities 215A-B, a vehicle computing system 100 of the autonomous vehicle 105 can include a plurality of vehicle clients 245A-B, each associated with a different service entity 215A-B. For example, the autonomous vehicle 105 can include a first vehicle client 245A associated with a first service entity 215A and a second vehicle client 245B associated with a second service entity 215B (e.g., that is different than the first service entity 215A). A vehicle client can be a software platform component of the service entity's computing platform, that is stored onboard an autonomous vehicle 105. For example, a vehicle client can include firmware, software (e.g., a software application), etc. that is stored onboard the autonomous vehicle 105 (and/or in an offboard memory that is accessible by the autonomous vehicle 105) and that can allow the vehicle computing system 100 to communicate data to and/or obtain data from the operations computing system 225A-B associated with a service entity 215A-B. For example, a vehicle client 245A-B can allow the vehicle computing system 100 to receive data indicative of one or more vehicle service assignments from an associated service entity 215A-B. The vehicle client 245A-B can be provided to an autonomous vehicle 105 by an operations computing system 225A-B associated with a service entity 215A-B, provided to a vehicle provider computing system 210 that can then help implement the vehicle client 245A-B on the autonomous vehicle 105 (e.g., by communicating a configuration to the vehicle computing system 100), and/or other approaches.

In some implementations, the operations computing system 225A-B and the vehicle computing system 100 can indirectly communicate. For example, the vehicle provider computing system 210 can serve as an intermediary between the operations computing system 225A-B and the vehicle computing system 100 such that at least some data is communicated from the operations computing system 225A-B (or the vehicle computing system 100) to the vehicle provider computing system 210 and then to the vehicle computing system 100 (or the operations computing system 225A-B).

A vehicle client 245A-B can be implemented via hardware and/or software onboard the autonomous vehicle 105. The vehicle computing system 100 can utilize the vehicle client 245A-B to access an application programming interface 250A-B associated with a service entity 215A-B. For example, the vehicle computing system 100 can invoke, via a vehicle client 245A-B, the application programming interface 250A-B to access a library indicative of a plurality of API parameters. The library can include, for example, a central repository for API parameters that can be used to generate a communication (e.g., query string, message, data set, etc.) to be sent to the service entity's operations computing system. In some implementations, each service entity 215A-B can be associated with a different application programming interface 250A-B. For example, a first service entity 215A can be associated with a first application programming interface 250A and a second service entity 215B can be associated with a second application programming interface 250B (e.g., which is different from the first application programming interface 250A). Additionally, or alternatively, one or more service entities can utilize the same application programming interface and/or the first and second application programming interfaces 250A-B can be the same (or at least similar).

A user 230 can request a vehicle service from a service entity 215A-B. For example, the user 230 can provide user input to a user device 235 to request a vehicle service (e.g., via a user interface associated with a mobile software application of the service entity, etc.). The user device 235 can communicate (e.g., directly and/or indirectly via another computing system) data 240 indicative of a request for a vehicle service to an operations computing system 225A-B associated with the service entity 215A-B. The request can indicate the type of vehicle service that the user 230 desires (e.g., a transportation service, a delivery service, a courier service, etc.), one or more locations (e.g., an origin location, a destination location, etc.), timing constraints (e.g., pick-up time, drop-off time, deadlines, etc.), a number of user(s) and/or items to be transported in the vehicle, one or more other service parameters (e.g., a need for handicap access, a need for trunk space, etc.), and/or other information. The operations computing system 225A-B of the service entity 215A-B can process the data 240 indicative of the request and generate a vehicle service assignment that is associated with the service request.

The operations computing system 225A-B of the service entity 215A-B can process the request and identify one or more autonomous vehicles that may be able to perform the requested vehicle services for the user 230. For instance, the operations computing system 225A-B can identify which vehicle(s) are online with the service entity.

An autonomous vehicle can be online with a service entity so that the autonomous vehicle is available to obtain data indicative of a vehicle service assignment associated with the service entity, so that the autonomous vehicle is available to address a vehicle service assignment, so that the autonomous vehicle is available to perform a vehicle service for the service entity, etc. For example, an autonomous vehicle 105 can go online with a service entity. An autonomous vehicle that is online with a service entity can be, for example, a vehicle that has performed one or more of: launching a vehicle client associated with the service entity, accessing an API associated with the service entity, establishing a communication session with a computing system of the service entity, connecting to a computing platform and/or a telecommunications network of the service entity, and/or taken other actions to go online with the service entity. The online vehicle can be able to communicate with the serve entity's computing system, for example, to obtain data (e.g., data indicative of vehicle service assignments).

The vehicle computing system 100 can go online with the computing platform and/or a first telecommunications network 220A of a first service entity 215A such that the autonomous vehicle 105 can communicate with the operations computing system 225A of the first service entity 215A. This can allow the vehicle computing system 100 to obtain data indicative of one or more vehicle service assignments associated with the first service entity 215A. By way of example, as described herein, the vehicle computing system 100 can include a first vehicle client 245A associated with the first service entity 215A. The vehicle computing system 100 can indicate the vehicle's availability to perform vehicle services and/or obtain vehicle service assignments from the first service entity. This can include launching the first vehicle client 245A. The vehicle computing system 100 can establish a first communication session with a first remote computing system associated with the first service entity 215A (e.g., the operations computing system 225A). The communication session can be opened based at least in part on a first application programming interface 250A associated with the first service entity 215A. For instance, the vehicle computing system 100 can access, via the first vehicle client 245A, the first application programming interface 250A associated with the first service entity 215A. The vehicle computing system 100 can generate a first communication 265A (e.g., data string, etc.) based at least in part on the first application programming interface 250A (e.g., based on the defined parameters thereof, etc.). The first communication 265A can indicate that the autonomous vehicle 105 is online with the first service entity 215A. The first communication 265A can indicate that the autonomous vehicle 105 is available to perform at least one first vehicle service for the first service entity 215A, is available to obtain vehicle service assignment(s) associated with the first service entity 215A (e.g., a computing system associated therewith), etc. The vehicle computing system 100 can provide the first communication 265A to the operations computing system 225A of the first service entity 215A to indicate that the autonomous vehicle 105 is online with the first service entity 215A and that the autonomous vehicle 105 is available to perform vehicle service(s) for the first service entity 215A. Additionally, or alternatively, the vehicle computing system 100 can provide the first communication 265A to the vehicle provider computing system 210, which can provide the first communication 265A (or similar such data) to the operations computing system 225A to indicate that the autonomous vehicle 105 is online with the service entity and that the autonomous vehicle 105 is available to perform vehicle service(s) for the first service entity 215A. In some implementations, the vehicle provider computing system 210 can perform similar operations to communicate with the operations computing system of a service entity via an application programming interface.

A similar such approach can be utilized by the vehicle computing system 100 to go online with a second service entity 215B. For example, the vehicle computing system 100 can access, via the second vehicle client 245B, the second application programming interface 250B associated with the second service entity 215B. The vehicle computing system 100 can generate a second communication 265B based at least in part on the second application programming interface 250B. The second communication 265B can indicate that the autonomous vehicle 105 is online with the second service entity 215B. The second communication 265B can indicate that the autonomous vehicle 105 is available to perform at least one second vehicle service for the second service entity 215B and/or is available to obtain vehicle service assignment(s) associated with the second service entity 215B (e.g., a computing system associated therewith).

An autonomous vehicle can be offline with a service entity. For example, the autonomous vehicle 105 can be offline with the first service entity 215A such that the autonomous vehicle 105 is unavailable to perform the vehicle service(s) of the first service entity 215A (e.g., unavailable to obtain/accept vehicle service assignment(s)). While offline, however, the autonomous vehicle 105 may still be capable of obtaining information from the service entity 215A. For instance, the autonomous vehicle 105 (and/or an associated vehicle provider 205) can include a message data store (e.g., an inbox, message queue, etc.) that stores messages associated with the autonomous vehicle 105 while it is offline. This message data store can be accessible by the autonomous vehicle 105 (and/or an associated vehicle provider 205). The operations computing system of a service entity can communicate data messages for an autonomous vehicle 105 and such messages can be stored in the data store for the autonomous vehicle 105 (and/or an associated vehicle provider 205). The autonomous vehicle 105 (and/or an associated vehicle provider 205) can access the data store to obtain data indicative of a message such as, for example, an activation assignment from a service entity, data indicative of demand for vehicle services, data indicative of geographic areas (e.g., with a vehicle imbalance, etc.), and/or other information.

Example embodiments of the present disclosure describe operations and functions performed by an operations computing system, a vehicle provider computing system, and/or a vehicle computing system for illustrative purposes. One or more of the operations and functions described as being performed by one system can be performed by another. For example, the operations and functions of an operations computing system of a service entity can be performed by another computing system (e.g., the vehicle provider computing system 210, the vehicle computing system 100, etc.), and vice versa, and/or any combination thereof.

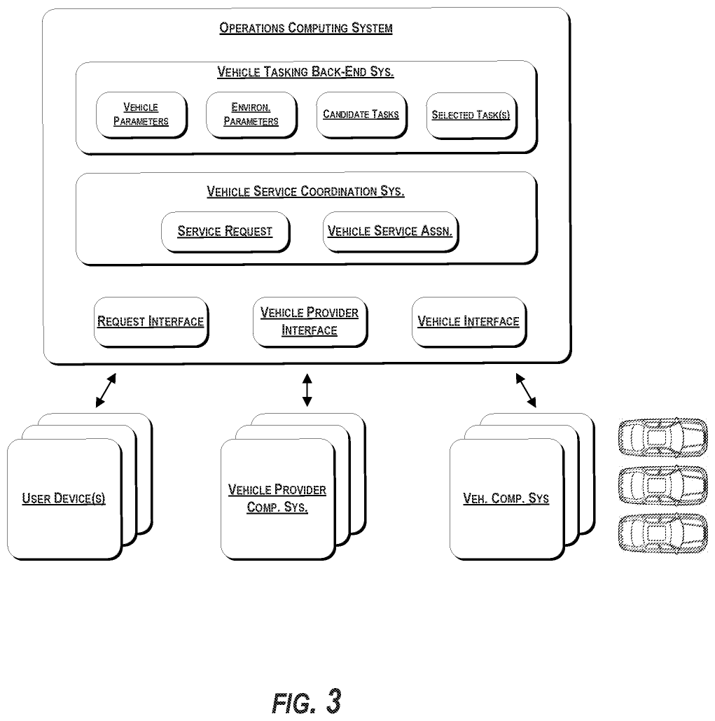

An operations computing system can be configured to select and assign tasks to vehicles (e.g., that are online with an associated service entity and in an idle state) to reduce vehicle downtime and idle data usage. FIG. 3 depicts an example operations computing system 300 of a service entity according to example embodiments of the present disclosure.

The operations computing system 300 can be associated with a service entity (e.g., service entities 215A-B). The operations computing systems 225A-B of FIG. 2 associated with the respective service entities 215A-B, and/or otherwise described herein, can be or can be configured in a similar manner to the operations computing system 300. The operations computing system 300 can include a vehicle service coordination system 305, a vehicle tasking system 310, and/or other systems.

The vehicle service coordination system 305 can be configured to coordinate the provision of one or more vehicle services to one or more users. For instance, the operations computing system 300 can include a request interface 315. The request interface 315 can allow the operations computing system 300 to communicate with one or a plurality of user devices 320 (e.g., mobile phones, desktops, laptops, tablets, game systems, etc.). The user device(s) 320 can be and/or can include the user device 235 of FIG. 2. The request interface 315 can allow the operations computing system 300 and the user device(s) 320 to communicate data to and/or from one another. For example, the user device(s) 320 can communicate (e.g., via the request interface 315) data indicative of a service request 325 for a vehicle service to an operations computing system 300 associated with a service entity.

The vehicle service coordination system 305 can be configured to generate a vehicle service assignment 330. A vehicle service assignment 330 can be indicative of a vehicle service (e.g., requested by a user via the user device(s) 320) to be performed by a vehicle (e.g., an autonomous vehicle). A vehicle service assignment 330 can include a variety of information associated with the vehicle service, the requesting user, the user device, the service entity, etc. For example, a vehicle service assignment 330 can include data indicative of an associated user and/or user device (if permitted), data indicative of a compensation parameter (e.g., the compensation for delivering an item to a user, couriering an item for a user, transporting a user, etc.), data indicative of one or more locations (e.g., origin location, destination location, intermediate location, etc.), data indicative of a type of vehicle service (e.g., transportation service, delivery service, courier service, etc.), data indicative of the type of cargo for the vehicle service (e.g., passengers, luggage, packages, food, time-sensitive mail, etc.), data indicative of a vehicle type/size (e.g., sedan, sport utility vehicle, luxury vehicle, etc.), data indicative of one or more time constraints (e.g., pick-up times, drop-off times, time limits for delivery, service duration, etc.), data indicative of user preferences (e.g., music, temperature, etc.), data indicative of one or more vehicle service parameters (e.g., luggage types, handle-with-care instructions, special pick-up requests, etc.), data indicative of the vehicle capacity required/preferred for the vehicle service (e.g., the number of seats with seatbelts, an amount of trunk space, etc.), data indicative of user ratings, data indicative of one or more vehicle service incentives (e.g., increased compensation, increased ratings, priority treatment, etc.), and/or other types of data.

The operations computing system 300 (e.g., the vehicle service coordination system 305) can identity one or more autonomous vehicles that are available for a vehicle service assignment 330. The vehicle service coordination system 305 can identify autonomous vehicle(s) that are online with the service entity associated with the operations computing system 300. The vehicle service coordination system 305 can select an autonomous vehicle for the vehicle service assignment based at least in part on the data indicated in the vehicle service assignment. For example, the vehicle service coordination system 305 can select an autonomous vehicle that meets the preferences of the user, has the necessary capacity, is the requested vehicle type, etc. Additionally, or alternatively, the vehicle service coordination system 305 can select an autonomous vehicle based at least in part on the current and/or future location of the autonomous vehicle. For example, the vehicle service coordination system 305 can select an autonomous vehicle that is proximate to an origin location associated with the vehicle service assignment 330. Additionally, or alternatively, the vehicle service coordination system 305 can select an autonomous vehicle that is within and/or nearby a geographic area that includes the origin location and/or destination location of the vehicle service assignment 330.

The operations computing system 300 can utilize a vehicle interface 335 to communicate data indicative of a vehicle service assignment 330 to one or more vehicle computing systems 340 of one or more autonomous vehicles 345. The vehicle computing system(s) 340 can include the vehicle computing system 100 and/or be configured in similar manner (e.g., as shown in FIG. 1) and the autonomous vehicle(s) 345 can include the autonomous vehicle 105. The vehicle interface 335 can allow the operations computing system 300 and one or a plurality of vehicle computing systems 340 (e.g., of one or a plurality of autonomous vehicles 345) to communicate data to and/or from one another. For example, the operations computing system 300 can communicate, via the vehicle interface 335, data indicative of a vehicle service assignment 330 to one or more vehicle computing system(s) 340 of the autonomous vehicles 345 that the operations computing system 300 selects for the vehicle service assignment 330. Additionally, or alternatively, the vehicle computing system(s) 340 can communicate data associated with the autonomous vehicle(s) 345 to the operations computing system 300. In this way, the operations computing system 300 can coordinate the performance of vehicle service(s) for user(s) by the autonomous vehicle(s) 345 as well as monitor the autonomous vehicle(s) 345.

In some implementations, the operations computing system 300 can select a non-autonomous vehicle (e.g., human driven vehicle) for a vehicle service assignment 330. For example, the vehicle service coordination system 305 can select a non-autonomous vehicle that is proximate to a location associated with the vehicle service assignment 330. Additionally, or alternatively, the vehicle service coordination system 305 can select a non-autonomous vehicle that is within and/or nearby a geographic area that includes the origin location and/or destination location of the vehicle service assignment 330. The operations computing system 300 can utilize a vehicle interface 335 to communicate data indicative of a vehicle service assignment 330 to one or more computing devices associated with the selected non-autonomous vehicle (e.g., a mobile device of the vehicle operator). The vehicle service assignment 330 can be indicative of a request that the operator provide the requested vehicle service to a user associated with the vehicle service assignment 330.

The operations computing system 300 can communicate with one or more vehicle provider computing systems 350 (associated with one or more vehicle providers) via a vehicle provider interface 355. The vehicle provider computing system(s) 350 can include and/or be configured in a similar manner to the vehicle provider computing system 210 (shown in FIG. 2). The vehicle provider computing system(s) 350 can be associated with vehicle providers that are associated with the autonomous vehicle(s) 345. The vehicle provider interface 355 can allow the operations computing system 300 and one or a plurality of vehicle provider computing systems 350 (e.g., of one or more vehicle providers, etc.) to communicate data to and/or from one another. For example, the operations computing system 300 can communicate, via the vehicle provider interface 355, data indicative of a vehicle service assignment 330, and/or other data as described herein, to one or more vehicle provider computing system(s) 350. The vehicle provider computing system(s) 350 can then communicate such data to the vehicle computing system(s) 340. Additionally, or alternatively, the vehicle provider computing system(s) 350 can communicate data associated with one or more autonomous vehicles 345 (and/or other data) to the operations computing system 300.

A service entity may have varying levels of control over the vehicle(s) that perform its vehicle services. In some implementations, a vehicle can be included in the service entity's dedicated supply of vehicles. The dedicated supply can include vehicles that are owned, leased, or otherwise exclusively available to the service entity (e.g., for the provision of its vehicle service(s), other tasks, etc.) for at least some period of time. This can include, for example, an autonomous vehicle 345 that is associated with a vehicle provider, but that is online only with that service entity (e.g., available to accept vehicle service assignments for only that service entity, etc.) for a certain time period (e.g., a few hours, a day, week, etc.).

In some implementations, a vehicle can be included in the service entity's non-dedicated supply of vehicles. This can include vehicles that are not exclusively available to the service entity. For example, an autonomous vehicle 345 that is currently online with two different service entities (e.g., concurrently online with a first service entity 215A and a second service entity 215B, etc.) so that the autonomous vehicle 345 may accept vehicle service assignment(s) 330 from either service entity (e.g., from the operations computing systems associated therewith, etc.) may be considered to be part of a non-dedicated supply of autonomous vehicles. In some implementations, whether a vehicle is considered to be part of the dedicated supply or the non-dedicated supply can be based, for example, on an agreement between the service entity and a vehicle provider associated with the autonomous vehicle 345.

An autonomous vehicle 345 can enter into an idle state while it is online with the service entity. An idle state can be a state in which the autonomous vehicle is online with a service entity and is not addressing a vehicle service assignment 330 and/or otherwise performing a vehicle service. This can include the time between vehicle service assignments 330. By way of example, an online autonomous vehicle can enter into an idle state after the autonomous vehicle 345 finishes performing a vehicle service for a first vehicle service assignment (e.g., drops off a user at a destination location in accordance with a trip request). The idle state can, thus, indicate the time at which the autonomous vehicle is available to perform a vehicle service but is not currently performing and/or assigned to one (e.g., traveling to an origin location, transporting an item/user, traveling to a destination location, etc.).

The operations computing system 300 can determine that an autonomous vehicle 345 is in an idle state. For instance, an autonomous vehicle can be online with a service entity. In some implementations, an autonomous vehicle 345 can communicate data to the operations computing system 300 indicating that the autonomous vehicle 345 has entered into an idle state and/or that the autonomous vehicle 345 has completed a vehicle service assignment 330. This data can be indicative of a vehicle's: a vehicle service state (e.g., idle, addressing a vehicle service assignment, etc.), online/offline status, the vehicle's current and/or future planned location, whether the vehicle is in the service entity's dedicated or non-dedicated supply, and/or other information. In some implementations, a vehicle provider computing system 350 (e.g., that is remote from the autonomous vehicle 345) can communicate such data to the operations computing system 300. In some implementations, the operations computing system 300 can monitor an autonomous vehicle 345 to determine that the autonomous vehicle 345 has entered into an idle state. For instance, the operations computing system 300 can obtain (e.g., from the autonomous vehicle 345, from the vehicle provider computing system 210, etc.) data indicating that the autonomous vehicle 345 has completed a first vehicle service assignment and can determine that the autonomous vehicle 345 is not assigned to a second vehicle service assignment.

The operations computing system 300 can aim to ensure that an autonomous vehicle 345 is productively utilizing its computational resources while it is in an idle state. To do so, the operations computing system 300 can determine a task for the autonomous vehicle to perform while the autonomous vehicle 345 is in the idle state. There may be a plurality of candidate tasks 360 for the autonomous vehicle 345 to perform and the operations computing system 300 can be configured to select the most appropriate task for that vehicle, as further described herein. A task can be associated with an activity other than the performance of a vehicle service (e.g., transportation service)

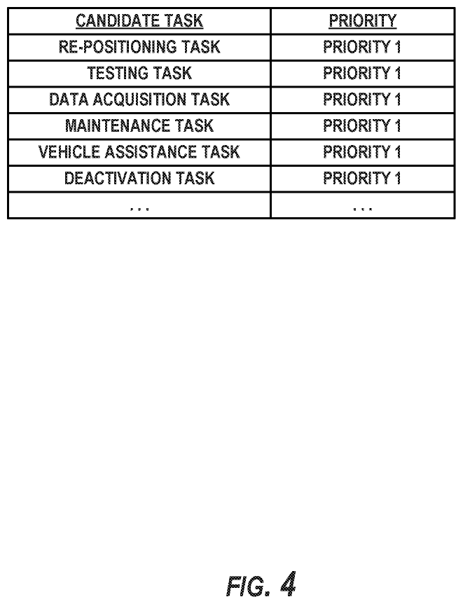

FIG. 4 depicts an example data structure 400 including a plurality of candidate tasks according to example embodiments of the present disclosure. The data structure 400 can be stored in an accessible memory 405. The data structure 400 can include a table, a hierarchy, a list, and/or other types of data structures. The data structure 400 can include data indicative of a plurality of candidate tasks 410A-H. The candidate tasks 360 of FIG. 3 can be or include the candidate tasks 410A-H. An operations computing system 345 (and/or another type of computing system) can access memory 405 to obtain data indicative of one or more of the candidate tasks 410A-H.

In some implementations, the tasks can be associated with the re-repositioning of an autonomous vehicle 345. This can include, for example, a supply re-positioning task 410A that instructs the autonomous vehicle 345 to travel from a current location within a first geographic area to another location within a second geographic area. The second geographic area can have an imbalance in a number of vehicles associated with the second geographic area. The imbalance can include a deficit in the number of vehicles (e.g., located within and/or proximate to that geographic area and available to perform vehicle services associated therewith) as compared to a demand for vehicle services. Additionally, or alternatively, the task can include a circling task 410G whereby the autonomous vehicle 345 is to travel within the current geographic area in which it is located (e.g., circle the block or neighborhood). Additionally, or alternatively, the tasks can be associated with making the autonomous vehicle stationary. This can include, for example, a parking task 410H by which the autonomous vehicle 345 is to park.

In some implementations, the tasks can be associated with the furtherance of a service entity's business and/or the development of autonomous vehicles associated with a service entity. Such a task can include, for example, a testing task 410B or a data acquisition task 410C. A testing task 410B can include the autonomous vehicle testing software and/or hardware that is implemented on the autonomous vehicle 345. This can include testing software associated with the vehicle's autonomy computing system (e.g., perception, prediction, motion planning, etc. software) and/or hardware (e.g., sensor hardware, etc.). A data acquisition task 410C can include acquiring sensor data associated with certain travel ways (e.g., for map generation, etc.) and/or the acquisition of sensor data associated with a condition in a geographic area (e.g., a scouting task to acquire sensor data associated with a travel way that has potentially changed, an obstruction, an accident, etc.).

In some implementations, the tasks can be associated with maintenance of the autonomous vehicle 345. For instance, a maintenance task 410D can include the autonomous vehicle 345 travelling to a service depot to receive scheduled maintenance, upgrade a software version, re-charge, re-fuel, and/or obtain other maintenance/servicing.

In some implementations, the tasks can be associated with assisting other vehicles. This can include a vehicle assistance task 410E by which the autonomous vehicle 345 in the idle state travels to assist another vehicle (e.g., autonomous vehicle, non-autonomous vehicle, etc.). For example, another autonomous vehicle may experience a fault such that the first autonomous vehicle performs a safe stop maneuver and pulls-over to the side of a travel way. The autonomous vehicle 345 (in an idle state) can be sent to assist the other autonomous vehicle by picking-up any users that are being transporting in the other autonomous vehicle. In another example, the sensors of another autonomous vehicle can be occluded (e.g., due to a barrier, obstruction, etc.). A vehicle assistance task 410E can instruct the autonomous vehicle 345 that is in an idle state to travel to a location that allows the other autonomous vehicle to acquire sensor data associated with the occluded area and transmit that sensor data to that autonomous vehicle. This can allow the occluded autonomous vehicle to understand what might be in the occluded area and plan its motion accordingly.

In some implementations, the autonomous vehicle 345 may be assigned a deactivation task 410F. This can include the autonomous vehicle 345 going offline with respect to the service entity. A deactivation task 410F can be considered a last resort in the event that another task is not available for the autonomous vehicle 345.

Returning to FIG. 3, various types of information can be acquired to help determine which task to select for an autonomous vehicle 345. For instance, the operations computing system 300 can obtain one or more vehicle parameters 365 associated with the autonomous vehicle 345 (e.g., that is in an idle state). The vehicle parameter(s) 365 can be data that is indicative of the past, present, and/or future state, operating conditions, characteristics, etc. associated with an autonomous vehicle 345. For example, the vehicle parameter(s) 365 can include data indicative of at least one of a current location of the autonomous vehicle 345, an electric charge level of the autonomous vehicle 345, a fuel level of the autonomous vehicle 345, an available data storage level of the autonomous vehicle 345, a maintenance schedule of the autonomous vehicle 345, a particular version of software implemented on the autonomous vehicle 345, a restriction associated with the autonomous vehicle 345 (e.g., geographic restriction, vehicle capability set, etc.), whether the vehicle is stopped, parked, etc.

In some implementations, the vehicle parameter(s) 365 can be indicative of a condition of the autonomous vehicle 345 relative to other autonomous vehicle(s) and/or geographic areas. For example, the vehicle parameter(s) 365 can include data indicative of a physical proximity of the autonomous vehicle 345 to other vehicles that are online with the service entity, a physical proximity of the autonomous vehicle 345 to a certain geographic area (e.g., one with a high level of vehicle service demand), etc.

In some implementations, the vehicle parameter(s) 365 can include data indicative of whether the autonomous vehicle 345 is associated with a third party vehicle provider (e.g., vehicle vendor). Additionally, or alternatively, the vehicle parameter(s) 365 can be indicative of a preference associated with an autonomous vehicle 345 and/or a third party vehicle provider associated therewith (e.g., preferred operating areas, preferred destination areas, preferred types of tasks, etc.), etc.

In some implementations, the vehicle parameter(s) 365 can be indicative of service-related information. For example, the vehicle parameter(s) 365 can include data indicative of an amount of time that the autonomous vehicle 345 has been in the idle state, a number of vehicle service assignments completed by the autonomous vehicle 345 (e.g., the number of trips taken by the autonomous vehicle), a vehicle service assignment requirement associated with the autonomous vehicle 345 and/or a third party vehicle provider (e.g., the number of trips that the autonomous vehicle is required to take in a given day), etc.

Additionally, or alternatively, the operations computing system can obtain one or more environmental parameters 370 associated with at least one of an environment in which the autonomous vehicle 345 is operating or the service entity. For example, the environmental parameter(s) 370 can include data indicative of a weather condition (e.g., rain, snow, etc.), a traffic condition (e.g., traffic patterns, congestion levels, etc.), an event (e.g., concert, sporting event, protest, etc.), a fuel/charge price, available parking, service depot availability, and/or other information associated with a geographic area in which the autonomous vehicle is (or will be) located in or nearby.

In some implementations, the environmental parameter(s) 370 can be indicative of information associated with other vehicles. For example, the environmental parameter(s) 370 can be indicative of the location of other vehicles (e.g., autonomous vehicles, non-autonomous vehicles) that are online with the service entity and/or the location of one or more vehicles that are offline with the service entity.

In some implementations, the environmental parameter(s) 370 can be indicative of information associated with the service entity such as, for example, a past, current, and/or future projected demand for vehicle services. This can include data indicative of a past, current, and/or future projected volume of service requests for vehicles services. Additionally, or alternatively, the environmental parameter(s) 370 can include data indicative of a number of vehicles that are online with the service entity, one or more geographic area(s) in which the service entity offers vehicle services (e.g., a geographic area with an imbalance in a number of vehicles associated with the geographic area), etc.

The operations computing system 300 can determine a task for an autonomous vehicle 345 to perform while the autonomous vehicle 345 is in the idle state based at least in part on at least one of the one or more vehicle parameters 365 and/or based at least in part on at least one of the one or more environmental parameters 370. The operations computing system 300 can identify a plurality of candidate tasks 410A-H for an autonomous vehicle 345. The operations computing system can determine, from the plurality of candidate tasks 410A-H, a task for the autonomous vehicle 345 to perform while the autonomous vehicle 345 is in the idle state based at least in part on at least one of the one or more vehicle parameters 365 or the one or more environmental parameters 370.

In some implementations, the operations computing system 300 can utilize heuristics to rank tasks and/or determine which task is best for an autonomous vehicle 345. For example, the operations computing system 300 can utilize a rules-based model that is written to evaluate the different vehicle parameter(s) 365 and/or environmental parameter(s) 370 and rank tasks and/or select a task for the idle autonomous vehicle based at least in part on these parameter(s).

The operations computing system 300 can also, or alternatively, utilize a machine-learned model to determine a task for an autonomous vehicle 345 to perform while in the idle state. The model can be trained to evaluate the vehicle parameter(s) and/or environment parameter(s) as input data and rank tasks and/or determine a recommended task for an autonomous vehicle (which can be provided as output data). Such a machine-learned model can be or can otherwise include one or more various model(s) such as, for example, models utilizing boosted random forest techniques, support vector machines, neural networks (e.g., deep neural networks), or other multi-layer non-linear models. Neural networks can include convolutional neural networks, recurrent neural networks (e.g., long short-term memory recurrent neural networks), feed-forward neural networks, and/or other forms of neural networks. For instance, supervised training techniques can be performed to train the machine-learned model to rank and/or recommend one or more tasks for an autonomous vehicle 345 given a set of vehicle and/or environment parameters. Such training data can be based on labelled real-world data from past task rankings and/or determinations.

In some implementations, the operations computing system 300 can utilize a weighting scheme to determine which task to select for an autonomous vehicle 345. For instance, as shown in FIG. 4, each of the plurality of candidate tasks 410A-H can be associated with respective a priority 415A-H. For example, each task can be associated with a priority weight/value that is indicative of the importance, urgency, etc. of that task. In some implementations, the priority weight can be based at least in part on a specific geographic area. For example, for a newer market/geographic area, there may be a higher weight/value placed on a data acquisition task 410C (e.g., mapping tasks, scouting tasks, etc.) to help gain a further understanding of the market/area.

In some implementations, the weighting scheme can be a dynamic weighting scheme that changes based on current and/or future vehicle parameter(s) 365 and/or environmental parameter(s) 370. In this way, at least one of the priority weights 415A-I associated with at least one of the candidate tasks 410A-I can be based at least in part on at least one of the one or more vehicle parameters 365 or the one or more environmental parameters 370. For example, in the event that there are several distressed autonomous vehicles, a higher priority weight can be afforded to a vehicle assistance task 410E. In another example, a higher priority weight can be afforded to a maintenance task 410D in the event that an autonomous vehicle 345 requires more urgent maintenance. In some implementations, the weighting scheme can be based at least in part on vehicle capabilities, restrictions, and/or preferences. For example, in the event that an autonomous vehicle is restricted to operate within a certain geographic area (or a third party vehicle provider has indicated a preference as such), a higher priority weight can be afforded to a circling task 410G and/or another type of task that can be performed in that certain geographic area.

In some implementations, the operations computing system 300 can utilize a task hierarchy (e.g., stored in a hierarchical tree data structure) to rank tasks and/or determine a task for an autonomous vehicle 345. The task hierarchy can be indicative of the priority weights 415A-H of the candidate tasks for an autonomous vehicle 345. The task hierarchy can provide a data structure that ranks these tasks for selection based on the priority weights. For example, the task hierarchy can be indicative of a highest priority weight associated with a supply re-positioning task 410A (e.g., to increase the opportunity for the vehicle to receive a vehicle service assignment) and a lowest priority weight associated with a de-activation task 410F (e.g., whereby the vehicle goes offline). One or more other tasks (e.g., a vehicle assistance task 410E, circling task 410G, etc.) may be assigned a priority weight between the supply re-positioning task 410A and the de-activation task 410F. As further described herein, the operations computing system 300 can determine the task for an autonomous vehicle 345 based at least in part on a task hierarchy (e.g., by traversing the task hierarchy).

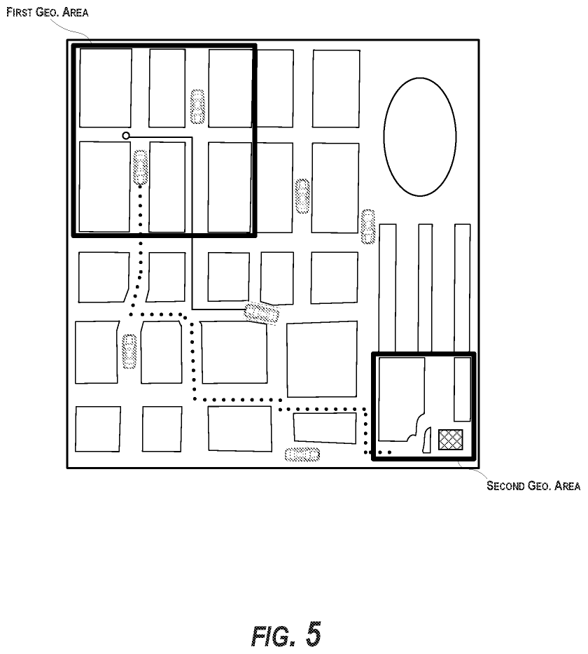

The operations computing system 300 can determine the task for the autonomous vehicle 345 based at least in part on the priorities associated with the plurality of candidate tasks. The following is an example of such task selection with reference to FIG. 5, which depicts an example region 500 with a first geographic area 505A and a second geographic area 505B. A first autonomous vehicle 510A can be located in the first geographic area 505A. The second geographic area 505B may have a vehicle imbalance (e.g., a deficit in the number of vehicles as compared to the volume of requests for vehicle services in the geographic area). The first autonomous vehicle 510A can enter into an idle state (e.g., after completing a vehicle service assignment).

The operations computing system 300 can determine a task for the first autonomous vehicle 510A to perform while the first autonomous vehicle 510A is in the idle state. For example, the operations computing system 300 can access the memory 405 to identify a plurality of candidate tasks 410A-H for the autonomous vehicle 345. The operations computing system 300 can analyze the data structure 400 indicative of the plurality of candidate tasks 410A-H (e.g., a task hierarchy) to select a task for the autonomous vehicle 345. The operations computing system 300 can determine, for example, that the supply re-positioning task 410A has a priority 415A that is higher than the priorities 415B-H associated with the other candidate tasks 410B-H.

The operations computing system 300 can determine whether or not the autonomous vehicle 345 can perform the supply re-positioning task 410A (the highest ranked candidate task). For instance, the operations computing system 300 can obtain data indicative of a geographic area (e.g., the second geographic area 505B) with an imbalance in a number of vehicles associated with the geographic area. The imbalance can include a deficit in the number of vehicles as compared to the demand for vehicle services. The operations computing system 300 can determine whether the first autonomous vehicle 510A can be re-positioned to the second geographic area 505B based at least in part on at least one of the one or more vehicle parameters 365 and/or the one or more environment parameters 370. If it is determined that the first autonomous vehicle 510A can be re-positioned to the second geographic area 505B, the operations computing system 300 can select the supply re-positioning task 410A associated with the second geographic area 505B for the first autonomous vehicle 510A to perform while in the idle state. By way of example, the operations computing system 300 can determine that the first autonomous vehicle 510A is to perform the supply re-positioning task 410A (e.g., re-locate to the second geographic area 505B) in the event that the first autonomous vehicle 510A is not restricted from travelling to the second geographic area 505B due to a vehicle provider preference, a traffic condition, a weather condition, etc.

If it is determined that the first autonomous vehicle 510A cannot be re-positioned to the second geographic area 505B (e.g., because traffic would prevent the first autonomous vehicle 510A from re-locating, etc.), the operations computing system 300 can select a different task for the first autonomous vehicle 510A to perform while in the idle state (e.g., a task other than the supply re-positioning task 410A). The operations computing system 300 can analyze the data structure 400 (e.g., the task hierarchy) to determine the next prioritized candidate task. For example, the operations computing system 300 can select a testing task 410B for the first autonomous vehicle 510A in the event that there is new software version in need of testing. In another example, in the event that the first geographic area 505A (in which the first autonomous vehicle 510A is operating) needs additional map data and/or has recently experienced a change in a condition (e.g., a redeveloped travel way), the operations computing system 300 can select a data acquisition task 410C for the first autonomous vehicle 510A. In another example, in the event that a second vehicle 510B (e.g., a second autonomous vehicle, a non-autonomous vehicle, etc.) has experienced a fault, the operations computing system 300 can select a vehicle assistance task 410E for the first autonomous vehicle 510A (e.g., to assist the distressed second vehicle 510B). In another example, in the event of an inclement weather event (e.g., hail), the operations computing system 300 can determine that the first autonomous vehicle 510A is to park within the first geographic area 505A in which it is located (e.g., in a designated covered parking area) and select a parking task 410H for the first autonomous vehicle 510A. In this way, the operations computing system 300 can evaluate the various candidate tasks 410A-I for the first autonomous vehicle 510A based on their assigned priorities 415A-I (e.g., by traversing the task hierarchy) as well as the vehicle parameter(s) 365 and/or environmental parameter(s) 370 to best select a task for the first autonomous vehicle 510A to perform while in an idle state.

Returning to FIG. 3, the operations computing system 300 can communicate data indicative of the selected task 375 for an autonomous vehicle 345 to perform while the autonomous vehicle 345 is in the idle state. Such data can be communicated directly or indirectly to an autonomous vehicle 345. For example, the operations computing system 300 can communicate data indicative of a selected task 375 directly to an autonomous vehicle 345 that is online with the service entity (e.g., via the service entity's platform/network, etc.). Additionally, or alternatively, data indicative of the selected task 375 can be communicated to a vehicle provider computing system 350 associated with the autonomous vehicle 345. The vehicle provider computing system 350 can communicate the data indicative of the selected task 375 to the autonomous vehicle 350 and/or determine whether the autonomous vehicle 345 should undertake the selected task 375.

The operations computing system 300 can confirm that an autonomous vehicle 345 has undertaken a selected task 375. For example, the operations computing system 300 can obtain data indicative of an acceptance of the task from an autonomous vehicle 345. Additionally, or alternatively, the operations computing system 300 can determine whether the autonomous vehicle 345 is acting in accordance with the task. For example, the operations computing system 300 can obtain data indicative of a vehicle's motion plan to determine whether the autonomous vehicle 345 intends to complete a task as instructed (e.g., re-positioning with respect a certain geographic area, performing a data acquisition task, travelling to assist a vehicle, travelling to a service depot for maintenance, etc.).

The operations computing system 300 can obtain data 380 indicative of a confirmation that an autonomous vehicle 345 has completed a task. Such data can be communicated by the vehicle computing system 340 of the autonomous vehicle 345 and/or a related vehicle provider computing system 350. The operations computing system 300 can confirm that the autonomous vehicle 345 has completed (or will soon complete) a selected task based at least in part on the data 380. Additionally, or alternatively, the operations computing system 300 can monitor the activity of an autonomous vehicle 345 to determine whether the autonomous vehicle 345 has completed the selected task 375 (e.g., arrived at the geographic area with a vehicle imbalance). Once the autonomous vehicle 345 completes a task (or nears completion of the task), the operations computing system 300 can determine whether to select another task for the autonomous vehicle 345 or, if available, communicate a vehicle service assignment 330 to the autonomous vehicle 345.

In some implementations, a selected task 375 can be overridden by a vehicle service assignment 330. An autonomous vehicle 345 which has been provided both a task 375 to perform and a vehicle service assignment 330 can prioritize performance of the vehicle service assignment 330 over performance of the task 375. For instance, an idle autonomous vehicle 345 can obtain data indicative of a selected task 375 and undertake the selected task 375. By way of example, the autonomous vehicle 345 can begin to travel to a geographic area that is experiencing vehicle imbalance, as instructed for a supply re-positioning task 410A. The operations computing system 300 may receive a service request 325 and generate a vehicle service assignment 300, as described herein. The operations computing system 300 can communicate data indicative of a vehicle service assignment 330 for the autonomous vehicle 345 (e.g., to the vehicle computing system 340, a vehicle provider computing system 350, etc.). Performance of the vehicle service assignment 330 by the autonomous vehicle 345 can be prioritized over performance of the selected task by the autonomous vehicle 345. For example, while en route to the geographic area (e.g., during performance of the task), the autonomous vehicle 345 may obtain the data indicative of vehicle service assignment 330. As such, the autonomous vehicle can accept and address the vehicle service assignment 330 (e.g., travel to pick-up a user, etc.), before completing the supply re-positioning task 410A.

In another example, the operations computing system 300 can communicate data indicative of a selected task 375 to an autonomous vehicle 345 that is currently addressing a vehicle service assignment 330 (e.g., travelling to pick-up a user/item, transporting the user/item, etc.). The operations computing system 300 may do so in order to forward deploy the selected task 375 so that the autonomous vehicle 345 will perform the selected task 375 after completing the current vehicle service assignment 330 (e.g., to proactively utilize the vehicle's potential idle time). In the event that the autonomous vehicle 345 obtains a subsequent vehicle service assignment 330, the autonomous vehicle 345 can perform the vehicle service assignment 330 before performing the task 375.

In some implementations, the operations computing system 300 can incentivize an autonomous vehicle 345 and/or an associated vehicle provider to undertake a task 375. For example, the operations computing system 300 can provide an autonomous vehicle 345 (or an associated vehicle provider) with a financial incentive, increased vehicle rating, priority treatment for vehicle service assignments, etc. as a method to incentivize the acceptance of the selected task 375.

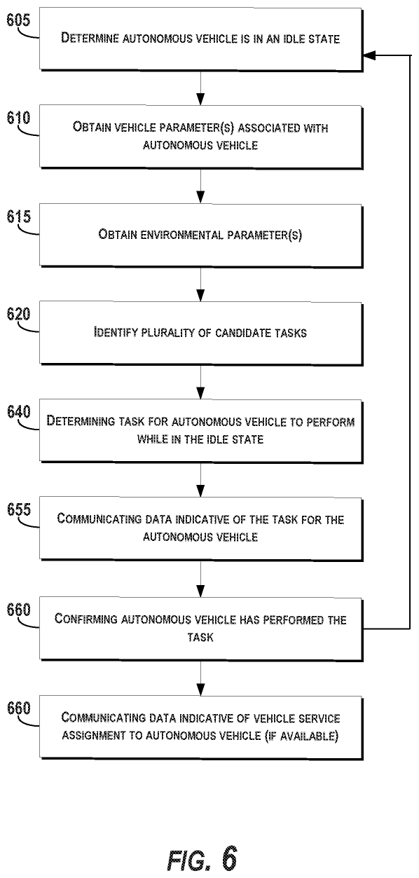

FIG. 6 depicts a flow diagram of an example method for controlling autonomous vehicles to reduce computational waste via idle task selection according to example embodiments of the present disclosure. One or more portion(s) of the method 600 can be implemented by a computing system that includes one or more computing devices such as, for example, the computing systems described with reference to the other figures (e.g., an operations computing system 225A-B, 300, a vehicle provider computing system 210, 350, a vehicle computing system 100, 340, etc.). Each respective portion of the method 600 can be performed by any (or any combination) of one or more computing devices. Moreover, one or more portion(s) of the method 600 can be implemented as an algorithm on the hardware components of the device(s) described herein (e.g., as in FIGS. 1-3 and/or 7), for example, to determine and assign tasks for idle autonomous vehicles. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 6 is described with reference to elements/terms described with respect to other systems and figures for example illustrated purposes and is not meant to be limiting. One or more portions of method 600 can be performed additionally, or alternatively, by other systems.

At (605), the method 600 can include determining that an autonomous vehicle is in an idle state. For instance, a computing system (e.g., the operations computing system 300) can determine that a first autonomous vehicle 510A is in an idle state in which the first autonomous vehicle 510A is online with a service entity (e.g., associated with the computing system) and is not performing a vehicle service (e.g., a transportation service). Such a determination can be made, for example, after the first autonomous vehicle 510A has completed a first vehicle service assignment but is not yet assigned a second vehicle service assignment.

At (610), the method 600 can include obtaining vehicle parameter(s) associated with an autonomous vehicle. For instance, the computing system (e.g., the operations computing system 300) can obtain one or more vehicle parameters associated with the first autonomous vehicle 510A that is in the idle state. As described herein, the one or more vehicle parameters can be indicative of various types of information associated with the first autonomous vehicle 510A. For example, the one or more vehicle parameters can include data indicative of at least one of a current location of the first autonomous vehicle 510A, an electric charge level of the first autonomous vehicle 510A, a fuel level of the first autonomous vehicle 510A, an available data storage level of the first autonomous vehicle 510A, an amount of time the first autonomous vehicle 510A has been in the idle state, a physical proximity to one or more second vehicles that are online with the service entity (e.g., second vehicle 510B), a restriction associated with the first autonomous vehicle 510A, or a preference associated with the first autonomous vehicle 510A.

Additionally, or alternatively, at (615), the method 600 can include obtaining environmental parameter(s). For instance, the computing system (e.g., the operations computing system 300) can obtain one or more environmental parameters. As described herein, the one or more environmental parameters can be indicative of various types of information associated with an environment in which the first autonomous vehicle 510 is (has, or may be) operating or a service entity. The one or more environmental parameters can include, for example, data indicative of at least one of a weather condition, a traffic condition, an event, one or more locations of one or more second vehicles that are online with the service entity, a volume of service requests for vehicle services, or a geographic area with an imbalance in a number of vehicles associated with the geographic area.

At (620), the method 600 can include identifying a plurality of candidate tasks for an autonomous vehicle. For instance, the computing system (e.g., the operations computing system 300) can identify a plurality of candidate tasks for the first autonomous vehicle 510A that is in the idle state. As described herein, the plurality of candidate tasks can include various types of tasks that the first autonomous vehicle 510A may perform while it is in the idle state. By way of example, the plurality of candidate tasks can include, a re-positioning task, a testing task, a data acquisition task, a maintenance task, a vehicle assistance task, a deactivation task, a circling task, a parking task, and/or other types of tasks.

At (625), the method 600 can include determining a task for an autonomous vehicle to perform while in the idle state. For instance, the computing system (e.g., the operations computing system 300) can determine a task for the first autonomous vehicle 510A to perform while the first autonomous vehicle 510A is in the idle state based at least in part on at least one of the one or more vehicle parameters or the one or more environmental parameters. The computing system can identify the plurality of candidate tasks for the first autonomous vehicle 510A and can select, from the plurality of candidate tasks, a task for the first autonomous vehicle 510A to perform while the first autonomous vehicle 510A is in the idle state.

In some implementations, each of the plurality of candidate tasks can be associated with a priority weight. The priority weight can be indicative of the importance, urgency, etc. associated with the respective task. As described herein, at least one of the priority weights associated with at least one of the candidate tasks can be based at least in part on at least one of the one or more vehicle parameters or the one or more environmental parameters. For instance, a vehicle assistance task can be given a higher priority in the event that there is an increase in the number of distress vehicles within a certain geographic area.

The computing system can select a task for the first autonomous vehicle 510A based at least in part on the priorities associated with each candidate task. For example, the plurality of candidate tasks can include a supply re-positioning task, a deactivation task, and at least one other task (e.g., a testing task, a data acquisition task, a circling task, a parking task, a vehicle assistance task, etc.). The first autonomous vehicle 510A can be located in a first geographic area 505A. A supply re-positioning task can include the first autonomous vehicle 510A traveling to a second geographic area 505B with an imbalance in a number of vehicles associated with the second geographic area 505B (e.g., a vehicle deficit). The deactivation task can include the first autonomous vehicle going offline with the service entity. A first priority weight associated with the supply re-positioning task can be greater than at least one second priority weight associated with the at least one other task (e.g., the testing task) and the at least one second priority weight can be greater than a third priority weight associated with the deactivation task. This can allow the supply re-positioning task to be selected for the first autonomous vehicle 510A if possible and, as a last resort, the deactivation task can be selected.

The computing system can select other types of tasks for the first autonomous vehicle 510A. These tasks can have priorities that are lower than a supply re-positioning task but higher than a deactivation task. The selection of these tasks can depend on the circumstances of the first autonomous vehicle 510A (as understood by evaluating the vehicle parameters and/or environment parameters). For example, the computing system can determine that the task for the first autonomous vehicle 510A to perform while in the idle state includes at least one of a testing task or a data acquisition task. As described herein, the testing task can include testing at least one of software or hardware implemented on the first autonomous vehicle 510A and the data acquisition task can include acquiring sensor data associated with a geographic area. In another example, the computing system can determine that the task for the first autonomous vehicle 510A to perform while in the idle state includes a circling task. The first autonomous vehicle 510A can be located in a first geographic area 505A. The circling task can include the first autonomous vehicle 510A traveling within the first geographic area 505B. In another example, the computing system can determine that the task for the first autonomous vehicle 510A to perform while in the idle state includes a vehicle assistance task. The vehicle assistance task can include the first autonomous vehicle 510A travelling to a location of a second autonomous vehicle 510B that is online with the service entity to provide assistance to the second autonomous vehicle 510B.

At (630), the method 600 can include communicating data indicative of the task for the autonomous vehicle. For instance, the computing system (e.g., the operations computing system 300) can communicate data indicative of the task for the first autonomous vehicle 510A to perform while the first autonomous vehicle 510A is in the idle state. Such data can be communicated directly to the first autonomous vehicle 510A or indirectly to the first autonomous vehicle 510A, as described herein. The data indicative of the task for the first autonomous vehicle 510A can include, for example, data indicative of one or more locations associated with the selected task (e.g., the location of a geographic area, the location of a distress vehicle, the location of an area to acquire sensor data, etc.), a route (e.g., to another geographic area, a route to a distress vehicle, a path for testing software/hardware, etc.), and/or any other operating parameters for the first autonomous vehicle 510A to implement while performing the task. In some implementations, the data indicative of the selected task can include one or more control command signals to instruct the first autonomous vehicle 510A to perform the selected task. In some implementations, the data indicative of the selected task can include a request that the first autonomous vehicle 510A perform the selected task. In response, the first autonomous vehicle 510A can accept or deny the requested task. Such an implementation may be utilized for vehicles that are part of a service entity's non-dedicated supply. In some implementations, the data indicative of the selected task can include an incentive (e.g., financial incentive) to entice the first autonomous vehicle 510A (and/or an associated vehicle provider) to accept and perform the selected task.

At (635), the method 600 can include confirming that an autonomous vehicle has performed a selected task. For instance, a computing system (e.g., the operations computing system 300) can obtain data indicative of a confirmation that the first autonomous vehicle 510 has completed the task, as described herein. In the event that there is not a vehicle service assignment to provide to the first autonomous vehicle 510A (e.g., the first autonomous vehicle 510A remains in the idle state), the computing system can repeat one or more portions of method 600. This can allow the computing system to determine a second task for the first autonomous vehicle 510A to perform while the first autonomous vehicle 510A is in the idle state.

In some implementations, at (640), the method 600 can include communicating data indicative of a vehicle service assignment to an autonomous vehicle. For instance, in the event that a vehicle service assignment is available for the first autonomous vehicle 510A, the computing system can communicate data indicative of the vehicle service assignment for the first autonomous vehicle 510A (e.g., to the vehicle's computing system, an associated vehicle provider computing system, etc.). The performance of the vehicle service assignment by the first autonomous vehicle 510 can be prioritized over performance of a selected task (if any) by the first autonomous vehicle 510A.

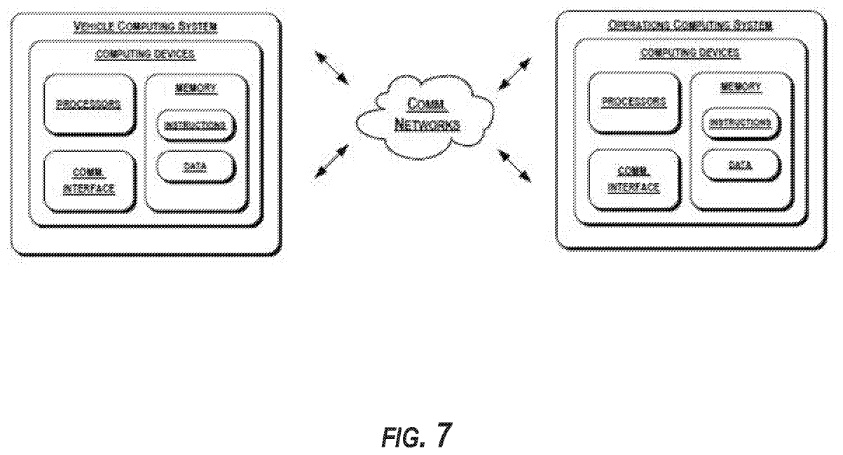

FIG. 7 depicts an example system 700 according to example embodiments of the present disclosure. The example system 700 illustrated in FIG. 7 is provided as an example only. The components, systems, connections, and/or other aspects illustrated in FIG. 7 are optional and are provided as examples of what is possible, but not required, to implement the present disclosure. The example system 700 can include a vehicle computing system 705 of a vehicle. The vehicle computing system 705 can represent/correspond to the vehicle computing systems 100, 340 described herein. The example system 700 can include a remote computing system 750 (e.g., that is remote from the vehicle computing system). The remote computing system 750 can represent/correspond to any of the operations computing systems (e.g., 225A-B, 300) described herein and/or the vehicle provider computing systems 210, 350 described herein. The vehicle computing system 705 and the remote computing system 750 can be communicatively coupled to one another over one or more network(s) 740.

The computing device(s) 710 of the vehicle computing system 705 can include processor(s) 715 and a memory 720. The one or more processors 715 can be any suitable processing device (e.g., a processor core, a microprocessor, an ASIC, a FPGA, a controller, a microcontroller, etc.) and can be one processor or a plurality of processors that are operatively connected. The memory 720 can include one or more non-transitory computer-readable storage media, such as RAM, ROM, EEPROM, EPROM, one or more memory devices, flash memory devices, data registrar, etc., and combinations thereof.

The memory 720 can store information that can be accessed by the one or more processors 715. For instance, the memory 720 (e.g., one or more non-transitory computer-readable storage mediums, memory devices) on-board the vehicle can include computer-readable instructions 725 that can be executed by the one or more processors 715. The instructions 725 can be software written in any suitable programming language or can be implemented in hardware. Additionally, or alternatively, the instructions 725 can be executed in logically and/or virtually separate threads on processor(s) 715.

For example, the memory 720 can store instructions 725 that when executed by the one or more processors 715 cause the one or more processors 715 (the vehicle computing system 705) to perform operations such as any of the operations and functions of the vehicle computing system 100 (or for which it is configured), one or more of the operations and functions of the vehicle provider computing systems (or for which it is configured), one or more of the operations and functions of the operations computing systems described herein (or for which it is configured), one or more of the operations and functions for identifying/ranking/determining a task for a vehicle, one or more portions of method 600, and/or one or more of the other operations and functions of the computing systems described herein.

The memory 720 can store data 730 that can be obtained (e.g., acquired, received, retrieved, accessed, created, stored, etc.). The data 730 can include, for instance, sensor data, map data, vehicle state data, perception data, prediction data, motion planning data, data associated with a vehicle client, data associated with a service entity's telecommunications network, data associated with an API, data associated with a library, data associated with library parameters, data associated with vehicle service incentives, data associated with idle state entry, data associated with selected tasks, data associated with acceptances and/or rejections of tasks and/or vehicle service assignments, and/or other data/information such as, for example, that described herein. In some implementations, the computing device(s) 710 can obtain data from one or more memories that are remote from the vehicle computing system 705.

The computing device(s) 710 can also include a communication interface 735 used to communicate with one or more other system(s) on-board a vehicle and/or a remote computing device that is remote from the vehicle (e.g., of the system 750). The communication interface 735 can include any circuits, components, software, etc. for communicating via one or more networks (e.g., network(s) 740). The communication interface 735 can include, for example, one or more of a communications controller, receiver, transceiver, transmitter, port, conductors, software and/or hardware for communicating data.

The remote computing system 750 can include one or more computing device(s) 755 that are remote from the vehicle computing system 705. The computing device(s) 755 can include one or more processors 760 and a memory 765. The one or more processors 760 can be any suitable processing device (e.g., a processor core, a microprocessor, an ASIC, a FPGA, a controller, a microcontroller, etc.) and can be one processor or a plurality of processors that are operatively connected. The memory 765 can include one or more tangible, non-transitory computer-readable storage media, such as RAM, ROM, EEPROM, EPROM, one or more memory devices, flash memory devices, data registrar, etc., and combinations thereof.

The memory 765 can store information that can be accessed by the one or more processors 760. For instance, the memory 765 (e.g., one or more tangible, non-transitory computer-readable storage media, one or more memory devices, etc.) can include computer-readable instructions 770 that can be executed by the one or more processors 760. The instructions 770 can be software written in any suitable programming language or can be implemented in hardware. Additionally, or alternatively, the instructions 770 can be executed in logically and/or virtually separate threads on processor(s) 760.

For example, the memory 765 can store instructions 770 that when executed by the one or more processors 760 cause the one or more processors 760 to perform operations such as any of the operations and functions of the operations computing systems 225A-B, 300 described herein, any operations and functions of the vehicle provider computing systems, any of the operations and functions for which the operations computing systems and/or the vehicle computing systems are configured, one or more of the operations and functions of the vehicle computing system 100 described herein, one or more of the operations and functions for controlling a vehicle, one or more of the operations and functions for identifying/ranking/determining a task for a vehicle, one or more portions of method 600, and/or one or more of the other operations and functions described herein.

The memory 765 can store data 775 that can be obtained. The data 775 can include, for instance, data associated with service requests, communications associated with/provided by vehicles, data to be communicated to vehicles, application programming interface data, data associated with vehicles and/or vehicle parameters, data associated with geographic areas, data indicative of vehicle imbalances, data indicative of environmental parameters, data associated with candidate task(s), data associated with select task(s), data indicative of vehicles in non-idle or idle states, data associated with vehicle service incentives, data associated with vehicle service assignments, data associated with acceptances and/or rejections of tasks and/or vehicle service assignments, data associated with different service entities, data associated with fleet(s) of vehicles, and/or other data/information such as, for example, that described herein. In some implementations, the computing device(s) 755 can obtain data from one or more memories that are remote from the system 750 and/or are onboard a vehicle.

The computing device(s) 755 can also include a communication interface 780 used to communicate with one or more system(s) onboard a vehicle and/or another computing device that is remote from the system 750. The communication interface 780 can include any circuits, components, software, etc. for communicating via one or more networks (e.g., network(s) 740). The communication interface 780 can include, for example, one or more of a communications controller, receiver, transceiver, transmitter, port, conductors, software and/or hardware for communicating data.

The network(s) 740 can be any type of network or combination of networks that allows for communication between devices. In some embodiments, the network(s) 740 can include one or more of a local area network, wide area network, the Internet, secure network, cellular network, mesh network, peer-to-peer communication link and/or some combination thereof and can include any number of wired or wireless links. Communication over the network(s) 740 can be accomplished, for instance, via a communication interface using any type of protocol, protection scheme, encoding, format, packaging, etc.

Computing tasks, operations, and functions discussed herein as being performed at a vehicle (e.g., via the vehicle computing system) can instead be performed by computing device(s) that are remote from the vehicle (e.g., via a vehicle provider computing system, an operations computing system, etc.), and/or vice versa. Moreover, operations, and functions discussed herein as being performed at a service entity (e.g., via an operations computing system) can instead be performed by other computing device(s) such as those of the vehicle provider computing system. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for controlling autonomous vehicles, comprising:
determining, by a computing system that comprises one or more computing devices, that a first autonomous vehicle is in an idle state in which the first autonomous vehicle is online with a service entity and is not performing a vehicle service;
obtaining, by the computing system, one or more vehicle parameters associated with the first autonomous vehicle that is in the idle state and one or more environmental parameters;
determining, by the computing system, a task for the first autonomous vehicle to perform while the first autonomous vehicle is in the idle state based at least in part on at least one of the one or more vehicle parameters or the one or more environmental parameters; and
communicating, by the computing system, data indicative of the task for the first autonomous vehicle to perform while the first autonomous vehicle is in the idle state.

2. The computer-implemented method of claim 1, wherein the one or more vehicle parameters comprise data indicative of at least one of a current location of the first autonomous vehicle, an electric charge level of the first autonomous vehicle, a fuel level of the first autonomous vehicle, an available data storage level of the first autonomous vehicle, an amount of time the first autonomous vehicle has been in the idle state, a physical proximity to one or more second vehicles that are online with the service entity, a restriction associated with the first autonomous vehicle, or a preference associated with the first autonomous vehicle.

3. The computer-implemented method of claim 1, wherein the one or more environmental parameters comprise data indicative of at least one of a weather condition, a traffic condition, an event, one or more locations of one or more second vehicles that are online with the service entity, a volume of service requests for vehicle services, or a geographic area with an imbalance in a number of vehicles associated with the geographic area.

4. The computer-implemented method of claim 1, wherein determining, by the computing system, the task for the first autonomous vehicle to perform while the first autonomous vehicle is in the idle state comprises:
identifying, by the computing system, a plurality of candidate tasks for the first autonomous vehicle; and
selecting, by the computing system from the plurality of candidate tasks, the task for the first autonomous vehicle to perform while the first autonomous vehicle is in the idle state.

5. The computer-implemented method of claim 4, wherein each of the plurality of candidate tasks is associated with a priority weight.

6. The computer-implemented method of claim 5, wherein at least one of the priority weights associated with at least one of the candidate tasks is based at least in part on at least one of the one or more vehicle parameters or the one or more environmental parameters.

7. The computer-implemented method of claim 5, wherein the plurality of candidate tasks comprises a supply re-positioning task, a deactivation task, and at least one other task, and wherein a first priority weight associated with the supply re-positioning task is greater than at least one second priority weight associated with the at least one other task, and wherein the at least one second priority weight is greater than a third priority weight associated with the deactivation task.

8. The computer-implemented method of claim 7, wherein the first autonomous vehicle is located in a first geographic area, and wherein the supply re-positioning task comprises traveling to a second geographic area with an imbalance in a number of vehicles associated with the second geographic area.

9. The computer-implemented method of claim 1, wherein the task for the first autonomous vehicle to perform while in the idle state comprises at least one of a testing task or a data acquisition task, wherein the testing task comprises testing at least one of software or hardware implemented on the first autonomous vehicle, and wherein the data acquisition task comprises acquiring sensor data associated with a geographic area.

10. The computer-implemented method of claim 1, wherein the task for the first autonomous vehicle to perform while in the idle state comprises a circling task, wherein the first autonomous vehicle is located in a first geographic area, wherein the circling task comprises the first autonomous vehicle traveling within the first geographic area.

11. The computer-implemented method of claim 1, wherein the task for the first autonomous vehicle to perform while in the idle state comprises a vehicle assistance task, wherein the vehicle assistance task comprises the first autonomous vehicle travelling to a location of a second autonomous vehicle that is online with the service entity to provide assistance to the second autonomous vehicle.

12. The computer-implemented method of claim 1, further comprising:
obtaining, by the computing system, data indicative of a confirmation that the first autonomous vehicle has completed the task; and
determining, by the computing system, a second task for the first autonomous vehicle to perform while the first autonomous vehicle is in the idle state.

13. A computing system comprising:
one or more processors; and
one or more tangible, non-transitory, computer readable media that collectively store instructions that when executed by the one or more processors cause the computing system to perform operations comprising:
determining that an autonomous vehicle is in an idle state, wherein the autonomous vehicle is online with a service entity;
obtaining one or more vehicle parameters associated with the autonomous vehicle that is in the idle state;
determining a task for the autonomous vehicle to perform while the autonomous vehicle is in the idle state based at least in part on at least one of the one or more vehicle parameters; and
communicating data indicative of the task for the autonomous vehicle to perform while the autonomous vehicle is in the idle state.

14. The computing system of claim 13, wherein determining that the autonomous vehicle is in the idle state comprises obtaining, from the autonomous vehicle, data indicating that the autonomous vehicle has completed a first vehicle service assignment and determining that the autonomous vehicle is not assigned to a second vehicle service assignment.

15. The computing system of claim 13, wherein determining the task for the autonomous vehicle to perform while the autonomous vehicle is in the idle state comprises determining the task for the autonomous vehicle based at least in part on a task hierarchy, wherein the task hierarchy is indicative of a highest priority associated with a supply re-positioning task and a lowest priority associated with a de-activation task.

16. The computing system of claim 13, wherein the operations further comprise:
communicating data indicative of a vehicle service assignment for the autonomous vehicle, wherein performance of the vehicle service assignment by the autonomous vehicle is prioritized over performance of the task by the autonomous vehicle.

17. The computing system of claim 13, wherein the operations further comprise:
obtaining one or more environmental parameters associated with at least one of an environment in which the autonomous vehicle is operating or the service entity; and
determining the task for the autonomous vehicle to perform while the autonomous vehicle is in the idle state based at least in part on at least one of the one or more environmental parameters.

18. One or more tangible, non-transitory, computer-readable media that collectively store instructions that, when executed by one or more processors, cause the one or more processors to perform operations, the operations comprising:
determining that an autonomous vehicle is in an idle state in which the autonomous vehicle is online with a service entity and is not assigned to a vehicle service assignment;
obtaining one or more vehicle parameters associated with the autonomous vehicle that is in the idle state and one or more environmental parameters;
identifying a plurality of candidate tasks for the autonomous vehicle;
determining, from the plurality of candidate tasks, a task for the autonomous vehicle to perform while the autonomous vehicle is in the idle state based at least in part on at least one of the one or more vehicle parameters or the one or more environmental parameters; and
communicating data indicative of the task for the autonomous vehicle to perform while the autonomous vehicle is in the idle state.

19. The one or more tangible, non-transitory, computer-readable media of claim 18, wherein determining the task for the autonomous vehicle to perform while the autonomous vehicle is in the idle state comprises:
obtaining data indicative of a geographic area with an imbalance in a number of vehicles associated with the geographic area, wherein the imbalance comprises a deficit in the number of vehicles; and
determining whether the autonomous vehicle can be re-positioned to the geographic area based at least in part on at least one of the one or more vehicle parameters or the one or more environment parameters;
wherein if it is determined that the autonomous vehicle can be re-positioned to the geographic area, the task for the autonomous vehicle to perform while in the idle state is a supply re-positioning task associated with the geographic area; and
wherein if it is determined that the autonomous vehicle cannot be re-positioned to the geographic area, the task for the autonomous vehicle to perform while in the idle state is a task other than the supply re-positioning task.

20. The one or more tangible, non-transitory, computer-readable media of claim 18, wherein each of the plurality of candidate tasks are associated with a priority, and wherein determining the task for the autonomous vehicle to perform while the autonomous vehicle is in the idle state comprises determining the task for the autonomous vehicle based at least in part on the priorities associated with the plurality of candidate tasks.
